(19) United States
(12) Patent Application Publication
(10) Pub. No.: US 2015/0142512 A1
(43) Pub. Date: May 21, 2015

(54) USER INFORMATION PROVIDING APPARATUS, USER INFORMATION PROVIDING METHOD, AND ADVERTISEMENT DISTRIBUTION SYSTEM

(71) Applicant: YAHOO JAPAN CORPORATION, Tokyo (JP)

(72) Inventors: Takayuki TSUCHIYA, Tokyo (JP); Hiroshi OTA, Tokyo (JP); Nobuyuki AKASHI, Tokyo (JP)

(21) Appl. No.: 14/487,861

(22) Filed: Sep. 16, 2014

(30) Foreign Application Priority Data
Nov. 15, 2013 (JP) 2013-236840

(51) Int. Cl. G06Q 30/02

(52) U.S. Cl. CPC G06Q 30/0269; G06Q 30/0201; G06Q 30/0261
USPC 705/7.29; 705/14.58

(57) ABSTRACT

A user information providing apparatus according to an embodiment includes a business operator information database, an information acquiring unit, a user information extracting unit, and a user information output unit. The business operator information database stores user information of a business operator. The information acquiring unit acquires information on an identification target provided in a place corresponding to the business operator from a user terminal. The user information extracting unit extracts user information of the business operator corresponding to the place where the identification target is provided from the business operator information database based on the information on the identification target acquired by the information acquiring unit. The user information output unit outputs the user information extracted by the user information extracting unit.

### CROSS-REFERENCE TO RELATED APPLICATIONS

The present application claims priority to and incorporates by reference the entire contents of Japanese Patent Application No. 2013-236840 filed in Japan on Nov. 15, 2013.

### BACKGROUND OF THE INVENTION

1. Field of the Invention

The present invention relates to a user information providing apparatus, a user information providing method, a user information providing program, and an advertisement distribution system.

2. Description of the Related Art

In recent years, with rapid spread of networks such as the Internet, distribution of advertisements via networks is performed vigorously. As one form of advertisement distribution, targeting advertising in which advertisements are distributes to users of which the user information meets distribution conditions (for example, attributes, interests, and concerns of users) designated by an advertiser is known (for example, refer to Japanese Patent Application Laid-open No. 2009-223423 A).

However, in the conventional advertisement distribution technique, advertisements are distributed based on the user information possessed by an advertisement distributor, and advertisements are not distributed as intended by an advertiser.

### SUMMARY OF THE INVENTION

A user information providing apparatus according to an embodiment includes a business operator information database, an information acquiring unit, a user information extracting unit, and a user information output unit. The business operator information database stores user information of a business operator. The information acquiring unit acquires information on an identification target provided in a place corresponding to the business operator from a user terminal. The user information extracting unit extracts user information of the business operator corresponding to the place where the identification target is provided from the business operator information database based on the information on the identification target acquired by the information acquiring unit. The user information output unit outputs the user information extracted by the user information extracting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a first explanatory diagram of a user information providing process according to a first embodiment;

FIG. 1B is a second explanatory diagram of the user information providing process according to the first embodiment;

FIG. 2 is a diagram illustrating an example of a specific configuration of an advertisement distribution system according to the first embodiment;

FIG. 3 is a diagram illustrating an example of a configuration of a user terminal according to the first embodiment;

FIG. 4 is a diagram illustrating a configuration example of a user information providing apparatus according to the first embodiment;

FIG. 5 is a diagram illustrating an example of a partner user information table;

FIG. 6 is a diagram illustrating an example of a behavior history information table;

FIG. 7 is a diagram illustrating an example of a partner company information table;

FIG. 8 is a diagram illustrating an example of a correspondence information table;

FIG. 9 is a diagram illustrating an example of a user information table;

FIG. 10 is a diagram illustrating an example of a configuration of an advertisement distribution apparatus according to an embodiment;

FIG. 11 is a diagram illustrating an example of an advertisement information table;

FIG. 12 is a flowchart illustrating information processing of the user terminal according to the first embodiment;

FIG. 13 is a flowchart illustrating information processing of the user information providing apparatus according to the first embodiment;

FIG. 14 is a flowchart illustrating information processing of the advertisement distribution apparatus according to the first embodiment;

FIG. 15 is a diagram illustrating a configuration example of a user information providing apparatus according to a second embodiment;

FIG. 16 is a diagram illustrating an example of an identification target list stored in a behavior history DB;

FIG. 17 is a diagram illustrating a stay state determination table stored in the behavior history DB;

FIG. 18 is a diagram illustrating a configuration example of a user information providing apparatus according to a third embodiment;

FIG. 19 is a diagram illustrating a configuration example of a user terminal according to the third embodiment;

FIG. 20 is a diagram illustrating a configuration example of a user terminal according to a fourth embodiment; and

FIG. 21 is a diagram illustrating a hardware configuration illustrating an example of a computer that realizes the functions of a user information providing apparatus and an advertisement distribution apparatus.

### DETAILED DESCRIPTION OF THE PREFERRED EMBODIMENTS

Hereinafter, embodiments of a user information providing apparatus, a user information providing method, a user information providing program, and an advertisement distribution system according to the present application will be described with reference to the drawings. The user information providing apparatus, the user information providing method, the user information providing program, and the advertisement distribution system according to the present application are not limited to these embodiments. In the following description, a database will be described as a DB.

### 1. First Embodiment

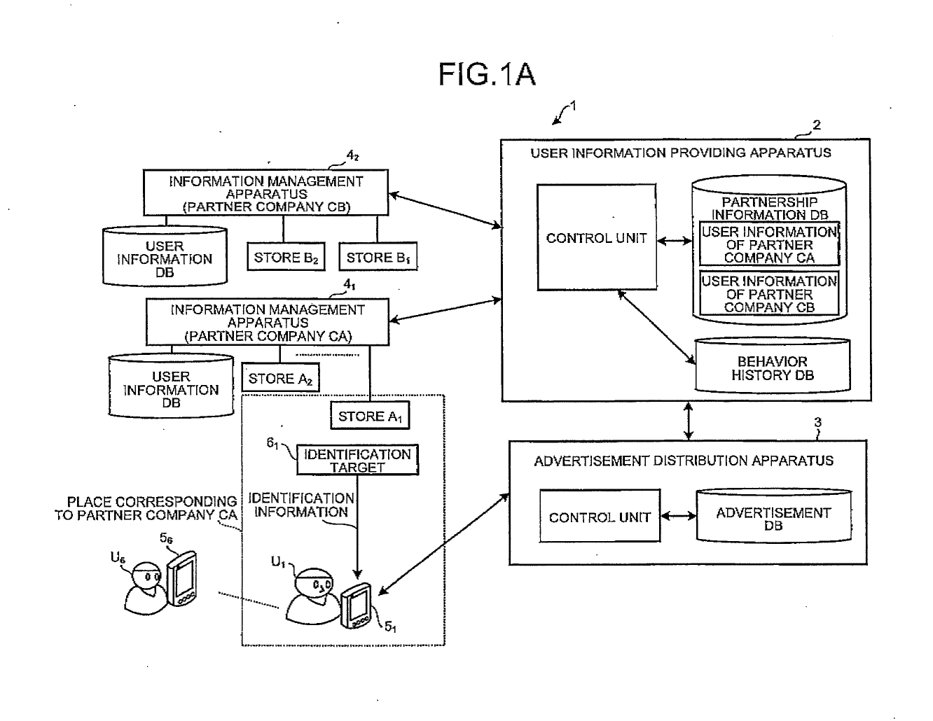

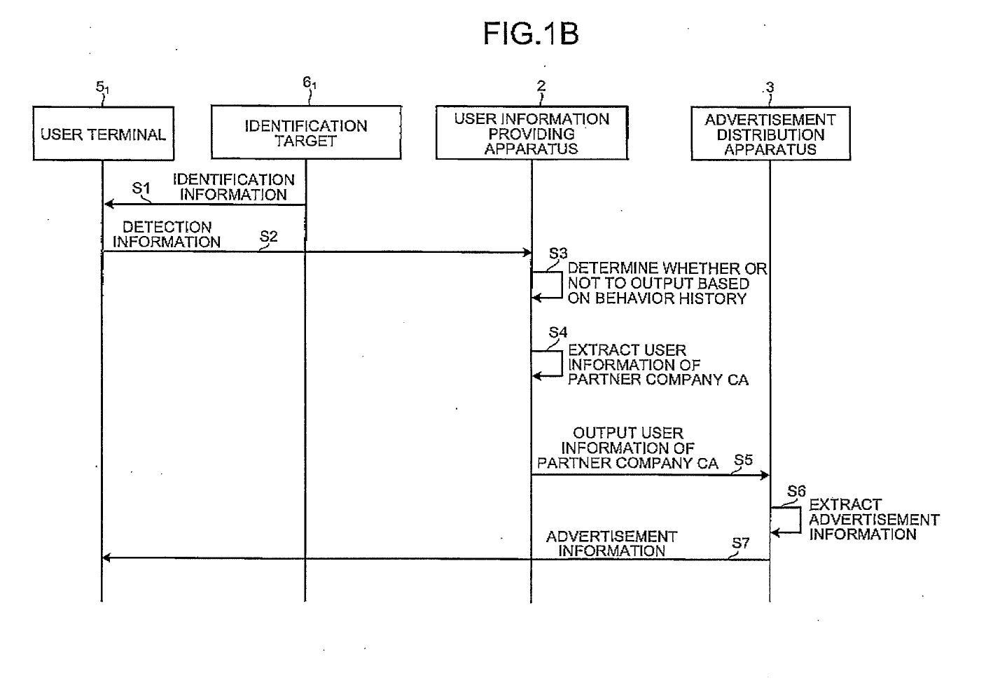

1.1. User Information Providing Process First, a user information providing process according to an embodiment will be described. FIGS. 1A and 1B are explanatory diagrams of a user information providing process according to an embodiment. In the present embodiment, the user information providing process is executed by an advertisement distribution system.

As illustrated in FIG. 1A, an advertisement distribution system 1 includes a user information providing apparatus 2, an advertisement distribution apparatus 3, and information management apparatuses 4₁ and 4₂. The user information providing apparatus 2 and the advertisement distribution apparatus 3 are managed and operated by an advertisement distributor, for example. Moreover, the information management apparatuses 4₁ and 4₂ (hereinafter sometimes referred to collectively as an information management apparatus 4) are managed and operated by partner companies CA and CB (hereinafter sometimes referred to collectively as a partner company C), respectively.

Moreover, user terminals 5₁ to 5₆ illustrated in FIG. 1A are user terminals held by users U₁ to U₆ who visit stores and facilities (hereinafter collectively referred to as stores) of the partner company C and purchase items and services in stores of the partner company C. In the following description, the user terminals 5₁ to 5₆ are sometimes referred to as a user terminal 5, and the users U₁ to U₆ are sometimes referred to as a user U. Moreover, the stores and facilities of the partner company C can be also referred to as branches of the partner company C.

The user terminal 5 is a portable wireless terminal such as a smartphone or a mobile personal computer (PC), for example, and can communicate various server apparatuses connected to a communication network (for example, the Internet) by wireless local area network (LAN) communication or mobile phone communication. The user terminal 5 may be a portable cable terminal that communicates with various server apparatuses connected to a communication network by cables instead of radio waves.

The partner company C is a business operator who has signed a partnership contract with an advertisement distributor, and for example, is a distributor who has stores providing items and services. The partner company CA is a business operator who provides items and services at stores A₁ and A₂, and the partner company CB is a business operator who provides items and services at stores B₂ and B₂. The partner company C is not limited to a distributor but may be a promoter of a concert or a sports, for example, and may be an operating company of a commercial space such as a hotel, a beauty parlor, a barber shop, a hospital, a movie theater, or a complex leisure facility.

Moreover, the information management apparatus 4₁ has a user information DB that stores user information possessed by the partner company CA, and the information management apparatus 4₂ has a user information DB that stores user information possessed by the partner company CB. The user information providing apparatus 2 acquires the user information of the partner companies CA and CB from the information management apparatuses 4₁ and 4₂ and stores the user information in a partnership information DB (an example of a business operator information DB).

Examples of the user information stored in the user information DB of the information management apparatus 4 include information (hereinafter sometimes referred to as behavior history information) on a visit history and a purchase history of a user U at a store of the partner company C and identification information (hereinafter referred to as a terminal ID) of the user terminal 5. The behavior history information also includes identification information (hereinafter referred to as a store ID) of the store of the partner company C, for example.

An identification target is provided in a place corresponding to the partner company C. For example, an identification target 6₁ is provided in a store A₁ illustrated in FIG. 1A. Moreover, although not illustrated in the drawing, identification targets 6₂, 6₃, 6₄, and the like are provided in stores A₂, B₁, and B₂. Hereinafter, the identification targets 6₁ to 6₄ are sometimes referred to as an identification target 6.

Examples of the identification target 6 include a one-dimensional barcode or a two-dimensional barcode (hereinafter simply referred to as a barcode) in addition to a radio communication device that performs communication such as wireless local area network (LAN), near field communication (NFC), or Bluetooth (registered trademark). The user terminal 5 acquires identification information (hereinafter referred to as an identification target ID) of the identification target 6 transmitted wirelessly from the identification target 6 and transmits the identification information to the user information providing apparatus 2. For example, the user terminal 5 acquires an identification target ID transmitted from a radio communication device and transmits the identification target ID to the user information providing apparatus 2. Moreover, the user terminal 5 converts a barcode captured by an image capturing unit into text information and transmits an identification target ID of the barcode to the user information providing apparatus 2.

When the identification target ID of the identification target 6 provided in the place corresponding to the partner company C is acquired from the user terminal 5, a control unit of the user information providing apparatus 2 outputs the user information of the partner company C corresponding to the place (hereinafter sometimes referred to as a user entering place) corresponding to the identification target ID to the advertisement distribution apparatus 3. The control unit of the user information providing apparatus 2 extracts a portion or all of the items of user information of the partner company C from the partnership information DB as the user information of the partner company C corresponding to the user entering place and outputs the user information to the advertisement distribution apparatus 3. In the following description, the user U of the user terminal 5 that has transmitted the identification target ID is sometimes referred to as an entering user U.

As an extraction target of the user information, “entering user U,” “all partner companies C,” “all entering stores,” and the like can be set for each partner company C. Moreover, the extraction target of the user information can be also set for each time slot, each weather, each day of the week, each week, each month, and each entering user U.

When the user U possessing the user terminal 5 enters a place corresponding to the partner company C to which the “entering user U” is set, the control unit of the user information providing apparatus 2 extracts the user information of the entering user U among the items of user information of the partner company C corresponding to the entering place of the user U from the partnership information DB. In this case, the control unit of the user information providing apparatus 2 may narrow down the entering stores to extract the user information from the partnership information DB.

Moreover, when the user U possessing the user terminal 5 enters a place corresponding to the partner company C to which “all partner companies C” are set, the control unit of the user information providing apparatus 2 extracts all items of user information of the partner company C corresponding to the entering place of the user U from the partnership information DB.

Moreover, when the user U possessing the user terminal 5 enters a place corresponding to the partner company C to which “all entering stores” are set, the control unit of the user information providing apparatus 2 extracts user information of an entering place (store) of the user U among the items of user information of the partner company C corresponding to the entering place of the user U from the partnership information DB.

Although the “place corresponding to the partner company C” is the inside of the store of the partner company C, for example, the “place corresponding to the partner company C” may include the inside and the surroundings of the store of the partner company C, and only the surroundings of the store of the partner company C may be the “place corresponding to the partner company C”. Moreover, the “place corresponding to the partner company C” is not limited to the store of the partner company C and the surroundings thereof but may be a place associated with the business of the partner company C. For example, the surroundings of a place where a poster including the information on the partner company C is posted, the surroundings of a place where a digital signage terminal for displaying the information on the partner company C is installed, an area (an event venue, an arcade, or the like) where the partner company C holds an event, and the like can be the “place corresponding to the partner company C”.

Moreover, the user information providing apparatus 2 includes a behavior history DB that stores a behavior history of the user U of the user terminal 5 that has transmitted the identification target ID. The control unit of the user information providing apparatus 2 can determine whether or not to output the user information to the advertisement distribution apparatus 3 based on the behavior history of the user U. Examples of the behavior history of the user U include an entering state into a place corresponding to the business operator of the user U, a usage state of coupon information of a place corresponding to the business operator of the user U, and an access state to the advertisement information of a place corresponding to the business operator of the user U.

In the user information providing apparatus 2, whether or not to output the user information to the advertisement distribution apparatus 3 based on the behavior history of the user U can be set for each partner company C, for each store, and for each user U, for example. When the determination on the behavior history is set, the user information providing apparatus 2 determines whether or not to output the user information to the advertisement distribution apparatus 3 based on the behavior history of the user U.

The advertisement distribution apparatus 3 includes an advertisement DB that stores a plurality of items of advertisement information. The advertisement information stored in the advertisement DB is information posted from an advertiser and includes advertisement information and distribution conditions. Examples of the distribution conditions include conditions that the user U who has acquired the identification target ID of the identification target 6 provided in the store of the partner company C is to be specified as a distribution destination and conditions that the user U who has acquired the identification target ID of the identification target 6 provided in a specific store of the partner company C is to be specified as a distribution destination.

The control unit of the advertisement distribution apparatus 3 acquires the advertisement information corresponding to the user information of the partner company C, acquired from the user information providing apparatus 2 from the advertisement DB and supplies the advertisement information to the user terminal 5 of the entering user U. For example, it is assumed that the user entering place is the place corresponding to the partner company CA. In this case, the control unit of the advertisement distribution apparatus 3 acquires advertisement information of which the user information acquired from the user information providing apparatus 2 satisfies distribution conditions among items of advertisement information posted under the distribution conditions that the entering user U of which the user entering place is the place corresponding to the partner company CA is to be specified as a distribution destination from the advertisement DB. Moreover, the control unit of the advertisement distribution apparatus 3 supplies the acquired advertisement information to the user terminal 5 of the entering user U.

Here, an example of the process performed when the user U₁ of the user terminal 5₁ visits the store A₁ will be described with reference to FIG. 1B.

When the user U₁ of the user terminal 5₁ enters the store A₁, the user terminal 5₁ acquires the identification target ID of the identification target 6₁ from the identification target 6₁ provided in the store A₁ (step S1). The user terminal 5₁ transmits detection information including the acquired identification target ID of the identification target 6₁ and the terminal ID of the user terminal 5₁ to the user information providing apparatus 2 via a communication network (step S2).

When the detection information is acquired from the user terminal 5₁, the control unit of the user information providing apparatus 2 determines whether or not to output the user information based on the behavior history of the user U₁ of the user terminal 5₁ (step S3). Specifically, the control unit of the user information providing apparatus 2 extracts the behavior history information corresponding to the terminal ID included in the detection information from the behavior history DB. The control unit of the user information providing apparatus 2 determines whether or not to provide the user information of the partner company CA corresponding to the place where the identification target 6₁ corresponding to the identification target ID included in the detection information is provided based on the extracted behavior history information.

Examples of the behavior history stored in the behavior history DB include the identification target ID of the identification target 6₁, acquired from the user terminal 5₁. For example, when the identification target ID of the identification target 6₁ is included in the behavior history DB, the control unit of the user information providing apparatus 2 determines that the user information is to be output.

When it is determined that the user information is to be output, the control unit of the user information providing apparatus 2 extracts the user information of the business operator corresponding to the user entering place from the partnership information DB (step S4). Specifically, the control unit of the user information providing apparatus 2 extracts a portion or all of the items of user information of the partner company CA corresponding to the identification target ID included in the detection information from the partnership information DB.

The control unit of the user information providing apparatus 2 outputs the extracted user information to the advertisement distribution apparatus 3 (step S5). In this way, it is possible to provide the user information of the partner company CA corresponding to the entering place of the entering user U₁ and the user information of the store A₁ which is the entering place to the advertisement distribution apparatus 3. Due to this, the advertisement distribution apparatus 3 can distribute advertisement information that designates the distribution conditions associated with the partner company CA to the user terminal 5₁ of the entering user U₁ and to perform highly accurate targeting advertising.

The control unit of the advertisement distribution apparatus 3 extracts advertisement information corresponding to the user information acquired from the user information providing apparatus 2 from the advertisement DB (step S6) and provides the advertisement information to the user terminal 5₁ of the entering user U₁ (step S7). In this way, the advertisement distribution apparatus 3 can provide advertisement information associated with the partner company CA to the user terminal 5₁ of the entering user U₁.

For example, an advertiser can distribute advertisement information to the user terminal 5 of the user U having designated user information among the users U using the partner company C by posting advertisement information of distribution conditions that designate the partner company C and the user attributes (for example, interests, concerns, and the like of the user U). Moreover, the advertiser can distribute advertisement information to the user terminal 5 of the user U having the user information corresponding to a designated store by further including designated stores in the distribution conditions.

Thus, for example, when a manufacturer as an advertiser who provides items exhibited in the store of the partner company C posts advertisement information to the advertisement distribution apparatus 3, it is possible to distribute the advertisement information by narrowing down to the user U of a predetermined partner company C and to promote purchase of items effectively and highly accurately.

Moreover, the user information of the partner company C includes a purchase history of items of a manufacturer and the like. Due to this, for example, it is possible to distribute the advertisement information by narrowing down to the user U who has a purchase history of the items advertised by the advertisement information. In this way, it is possible to promote purchase of items effectively and highly accurately.

Further, the user information providing apparatus 2 selects whether or not to provide user information based on the behavior history of the user U of the user terminal 5, That is, the user information providing apparatus 2 provides the user information of a place corresponding to the behavior history of the user U to the advertisement distribution apparatus 3 but does not provide the user information of a place that does not correspond to the behavior history of the user U to the advertisement distribution apparatus 3. Thus, it is possible to provide the advertisement information appropriate for the behavior of the user U of the user terminal 5 to the user U of the user terminal 5. Moreover, the advertiser can post advertisement information under distribution conditions that the user U who frequently goes to a certain place is designated as a target and the advertiser can distribute advertisements efficiently and effectively.

1.2. Configuration of Advertisement Distribution System 1

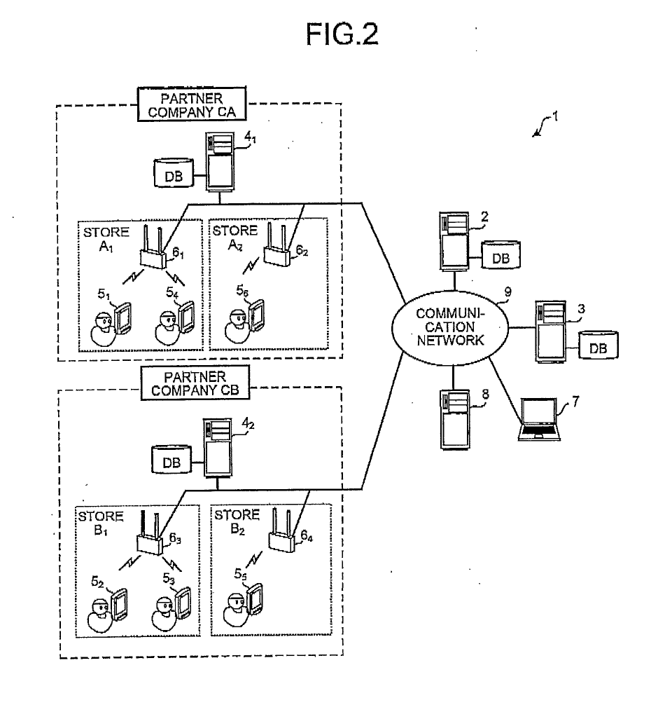

A configuration example of the advertisement distribution system 1 according to the embodiment will be described with reference to FIG. 2. FIG. 2 is a diagram illustrating a configuration example of the advertisement distribution system 1 according to the embodiment.

As illustrated in FIG. 2, the advertisement distribution System 1 includes the user information providing apparatus 2, the advertisement distribution apparatus 3, the information management apparatuses 4₁ and 4₂, the user terminals 5₁ to 5₆, the identification targets 6₁ to 6₄, an advertiser terminal 7, and a site server 8.

The user information providing apparatus 2, the advertisement distribution apparatus 3, the information management apparatus 4, the advertiser terminal 7, and the site server 8 are communicably connected via a communication network 9. The communication network 9 is a wide area network (WAN) such as the Internet, for example.

Although two partner companies CA and CB are illustrated in the example illustrated in FIG. 2, the number of partner companies C may be one and may be three or more. Moreover, at least one identification target 6 is provided in each store of the partner company C. In the example illustrated in FIG. 2, the identification targets 6₁ and 6₂ are provided in the stores A₁ and A₂ of the partner company CA, and the identification targets 6₃ and 6₄ are provided in the stores B₁ and B₂ of the partner company CB.

The user terminal 5 is a terminal apparatus having a wireless LAN communication function, for example, like a smartphone, a mobile PC, and the like, and can communicate with a wireless WAN base station (not illustrated). The wireless WAN base station is connected to the communication network 9. The user terminal 5 may be connected to the communication network 9 by cable communication instead of radio communication.

The identification target 6 may be a marker such as a barcode or a predetermined mark in addition to a communication device that performs communication such as wireless LAN, NFC, or Bluetooth (registered trademark). A communication area of NFC is approximately one meter to several centimeters, and examples of NFC include Felica, ISO/IEC 14443 (MIFARE). The communication of the identification target 6 may use infrared-ray communication, visible light communication, acoustic waves, human body communication, and cables without limiting to electric waves. Examples of human body communication include a body area network (BAN). The identification target 6 may not be connected to the communication network 9 and is not limited to the example illustrated in FIG. 2.

The site server 8 is managed and operated by an advertisement distributor, and provides various categories of webpages to the user terminal 5 via the communication network 9 in response to an access from the user terminal 5 via the communication network 9. Moreover, the site server 8 acquires advertisement information corresponding to the user ID of the user U of the accessing user terminal 5 from the advertisement distribution apparatus 3 and provides the advertisement information to the user terminal 5 by embedding the same in a webpage. The user ID of the user U is a login ID to the site server 8, for example.

Hereinafter, the configuration of the user terminal 5, the user information providing apparatus 2, and the advertisement distribution apparatus 3 will be described in order.

1.3. User Terminal 5

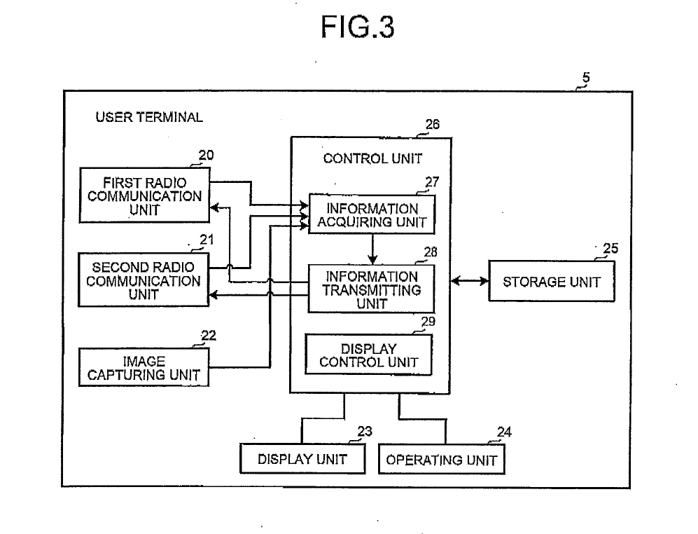

First, the configuration of the user terminal 5 will be described. FIG. 3 is a diagram illustrating a configuration example of the user terminal 5. As illustrated in FIG. 3, the user terminal 5 includes a first radio communication unit 20, a second radio communication unit 21, an image capturing unit 22, a display unit 23, an operating unit 24, a storage unit 25, and a control unit 26. The first radio communication unit 20 is a communication interface that transmits and receives information to and from the identification target 6. The second radio communication unit 21 is a communication interface that transmits and receives information to and from a wireless WAN base station (not illustrated). The wireless WAN base station is a wireless base station of a public telephone communication network or a wireless base station of a public data communication network, for example.

The image capturing unit 22 includes a charge coupled devices (CCD) image sensor, a complementary MOS (CMOS) image sensor, or the like. The image capturing unit 22 captures the image of the surroundings of the user terminal 5 to obtain image data and outputs the image data to the control unit 26.

The display unit 23 is a touch panel display. The user U of the user terminal 5 can operate an operation screen of an information notification card application displayed on the display unit 23 by operating with a finger or the like on the screen of the display unit 23. The display unit 23 is a small liquid crystal display (LCD) or an organic EL display, for example.

The operating unit 24 includes a keyboard including keys for inputting characters, numbers, and spaces, an enter key, a cursor key, and the like, a power button, and the like.

The storage unit 25 is a semiconductor memory device such as random access memory (RAM) or flash memory or a storage device such as a hard disk, for example. The storage unit 25 stores various programs. Examples of the programs stored in the storage unit 25 include an operating system (OS), the information notification card application program acquired from the information management apparatus 4, and the like.

Moreover, the user terminal 5 includes a reader (not illustrated), and the control unit 26 can read the information notification card application program recorded in a recording medium with the aid of the reader and store the same in the storage unit 25. Examples of the recording medium include an optical disc, a flexible disk, a hard disk, and the like.

The control unit 26 is realized by an integrated circuit such as, for example, ASIC or FPGA. Moreover, the control unit 26 realizes or executes the functions and operations of information processing described later when a CPU, an MPU, or the like executes the program stored in the storage unit 25 using internal RAM (not illustrated) as a work area, for example.

Specifically, the control unit 26 executes the information notification card application of which the program data is stored in the storage unit 25 to thereby function as an information acquiring unit 27, an information transmitting unit 28, and a display control unit 29. The control unit 26 is not limited to this configuration but may have another configuration as long as the control unit 26 performs the information processing described later.

The information acquiring unit 27 acquires the identification target ID of the identification target 6. Specifically, the information acquiring unit 27 acquires the identification information of the identification target 6 output from the identification target 6 with the aid of the first radio communication unit 20.

When the identification target 6 is a wireless LAN access point, the identification target ID of the identification target 6 is an extended service set identifier (ESS-ID) or a basic service set identifier (BSS-ID) of the wireless LAN access point. Moreover, when the identification target 6 is a device that performs Bluetooth (registered trademark) communication, the identification target ID of the identification target 6 is a universally unique identifier (UUID), for example. Further, when the identification target 6 is an NFC device, the identification target ID of the identification target 6 is the ID of the NFC device.

Moreover, when the identification target 6 is a barcode, the information acquiring unit 27 converts the image data of the barcode output from the image capturing unit 22 into text information and acquires the text information as the identification target ID of the identification target 6. Further, the information acquiring unit 27 may acquire predetermined image information (for example, all or a portion of the captured images of the identification target 6) identified from the captured image of the identification target 6 as the identification target ID of the identification target 6.

The information acquiring unit 27 receives the advertisement information transmitted from the advertisement distribution apparatus 3 in response to the detection information transmitted by the information transmitting unit 28. The information transmitted from the advertisement distribution apparatus 3 in response to the detection information may include news, surrounding information, and the like in addition to the advertisement information.

Moreover, the information acquiring unit 27 receives coupon information transmitted from the advertisement distribution apparatus 3 or the site server 8 and adds the received coupon information to the storage unit 25. Further, the information acquiring unit 27 receives the advertisement information transmitted from the advertisement distribution apparatus 3 and adds the received advertisement information to the storage unit 25.

The information transmitting unit 28 transmits detection information including the identification target ID acquired by the information acquiring unit 27 and the terminal ID stored in the storage unit 25 to the user information providing apparatus 2 via the first radio communication unit 20 or the second radio communication unit 21. When the identification target 6 is a radio communication device, the detection information includes information on radio field intensity. The radio field *intensity is the radio field intensity of radio signals from the identification target 6 received by the first radio communication unit 20.

Moreover, the information transmitting unit 28 transmits a request corresponding to an operation (hereinafter referred to as a user operation) of a user on the operating unit 24. For example, when access information of the advertisement information is selected by the user operation, the information transmitting unit 28 transmits a request for transmitting the advertisement information to an access destination based on the access information to an access destination apparatus via the first radio communication unit 20 or the second radio communication unit 21. The access destination apparatus is the advertisement distribution apparatus 3 or the site server 8, for example.

The display control unit 29 displays the information acquired from the advertisement distribution apparatus 3 or the site server 8 on the display unit 23. Moreover, the display control unit 29 displays the coupon information and the advertisement information stored in the storage unit 25 on the display unit 23.

1.4. User information Providing Apparatus 2

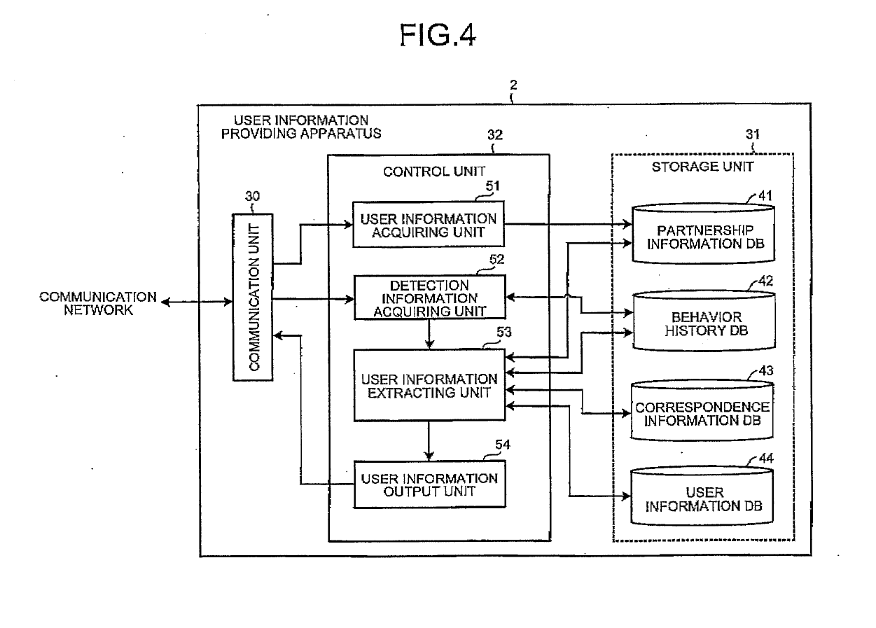

Next, the configuration of the user information providing apparatus 2 will be described in detail. FIG. 4 is a diagram illustrating an example of the configuration of the user information providing apparatus 2. As illustrated in FIG. 4, the user information providing apparatus 2 includes a communication unit 30, a storage unit 31, and a control unit 32.

The storage unit 31 includes a partnership information DB 41 (an example of a business operator information DB), a behavior history DB 42, a correspondence information DB 43, and a user information DB 44. Moreover, the control unit 32 includes a user information acquiring unit 51, a detection information acquiring unit 52, a user information extracting unit 53, and a user information output unit 54.

The communication unit 30 is an interface such as a network interface card (NIC), for example. The control unit 32 transmits and receives various items of information to and from the advertisement distribution apparatus 3, the information management apparatus 4, and the user terminal 5 via the communication unit 30 and the communication network 9.

The partnership information DB 41, the behavior history DB 42, the correspondence information DB 43, and the user information DB 44 are semiconductor memory devices such as RAM or flash memory or storage devices such as a bard disk, for example. The partnership information DB 41, the behavior history DB 42, the correspondence information DB 43, and the user information DB 44 may be constructed as one DB. Moreover, the correspondence information DB 43 and the user information DB 44 may not be provided, and the control unit 32 may acquire the information of the correspondence information DB and the user information DB provided in the advertisement distribution apparatus 3 from the advertisement distribution apparatus 3.

The control unit 32 functions as a user information acquiring unit 51, a detection information acquiring unit 52, a user information extracting unit 53, and a user information output unit 54 when an internal CPU or MPU executes the program stored in an internal storage device using RAM as a work area. The control unit 32 is not limited to this configuration but may have another configuration as long, as the control unit 32 can perform the information processing described later.

1.4.1. User Information Acquiring Unit 51

The user information acquiring unit 51 acquires the respective items of user information possessed by a plurality of partner companies CA and CB from the information management apparatuses 4₁ and 4₂ and stores the same in the partnership information DB 41. The respective items of user information are sequentially updated in the partner companies C, and the user information acquiring unit 51 acquires the updated user information and updates the user information of the partnership information DB 41.

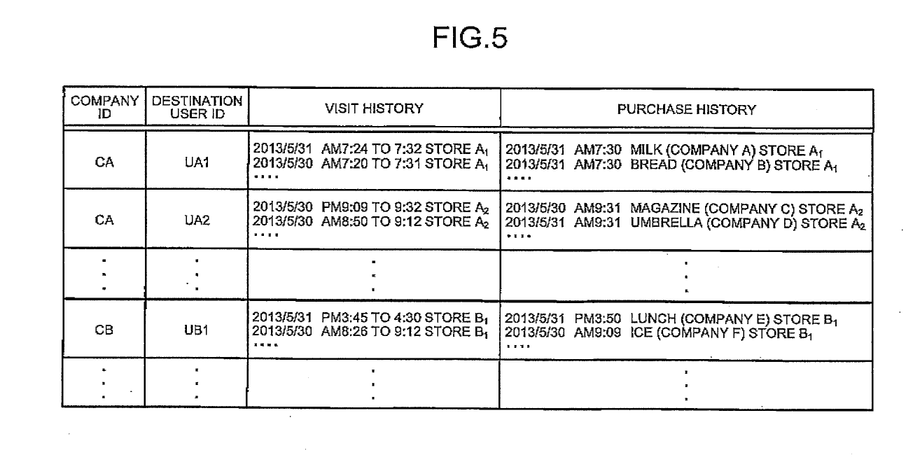

FIG. 5 is a diagram illustrating an example of a partner user information table stored in the partnership information DB 41. As illustrated in FIG. 5, the partner user information table is information associated with behavior history information such as a “company ID,” a “destination user ID,” a “visit history,” and a “purchase history”.

The “company ID” is identification information of the partner company C, and in the example illustrated in FIG. 5, “CA” is a company ID of the partner company CA and “CB” is a company ID of the partner company CB. In the example illustrated in FIG. 5, although the user information of the partner company CA and the user information of the partner company CB are set in the same partner user information table, management of the user information of the partner company C is not limited to this configuration.

For example, a partner user information table of each partner company C may be provided, and the user information may be set in the partner user information table corresponding to each partner company C. Moreover, the partnership information DB may be provided for each partner company C. By doing so, it is possible to manage the respective items of user information of the partner companies C in a sorted manner.

The “destination user ID” is a unique user ID of each partner company C and is allocated to the user U who uses the partner company C. In the example illustrated in FIG. 5, “UA1,” “UA2,” and the like are allocated to the partner company CA, and “UB1” and the like are allocated to the partner company CB. The company ID and destination user ID pair may be unique information, and the destination user ID of the partner company CA and the destination user ID of the partner company CB may be an overlapping ID.

The “visit history” is a visit history of the user U in the store or the like of the partner company C, and for example, as illustrated in FIG. 5, includes a visit date and a visit store. Moreover, the “purchase history” is a purchase history of the user U in the store of the partner company C, and for example, as illustrated in FIG. 5, includes information such as a purchase date, a purchase item (including a manufacturer name and an item name), and a purchase store.

The user information of the partner company C is not limited to that illustrated in FIG. 5, but may be information such as the age, the gender, the preference, a visit frequency, or an average amount of purchase, for example, and different information may be provided for respective partner companies C.

1.4.2. Detection Information Acquiring Unit 52

The detection information acquiring unit 52 acquires the detection information transmitted from the user terminal 5 and outputs the detection information to the user information extracting unit 53. Moreover, the detection information acquiring unit 52 stores the detection information transmitted from the user terminal 5 in the behavior history DB 42.

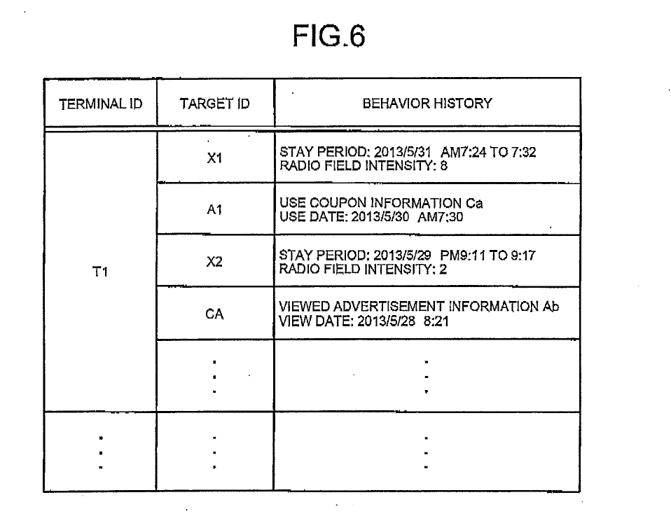

FIG. 6 is a diagram illustrating an example of a behavior information history table stored in the behavior history DB 42. As illustrated in FIG. 6, the behavior information history table is information associated with information such as a “terminal ID,” a “target ID,” and a “behavior history”.

The “terminal ID” is identification information of the user terminal 5 that has transmitted the detection information, and for example, is a MAC address of the first radio communication unit 20 of the user terminal 5 or unique identification information allocated by the information notification card application. The “target ID” is an identification target ID of the identification target 6, a store ID of a store, or a company ID of the partner company C.

The “behavior history” is information indicating the content of a behavior of the user U of the user terminal 5. For example, the behavior history of the behavior information history table illustrated in FIG. 6 includes information such as a stay period and radio field intensity in the user entering place.

The stay period and the radio field intensity are set in the behavior information history table by the detection information acquiring unit 52 based on the detection information. The radio field intensity is radio field intensity of radio signals from the identification target 6 received by the first radio communication unit 20.

Moreover, the behavior history of the behavior information history table illustrated in FIG. 6 includes information indicating the usage state of coupon information in the place where the identification target 6 is provided. The information indicating the usage state of the coupon information includes information on the content of the coupon information and the use date. The information indicating the usage state of the coupon information is information notified from the user terminal 5 or the information management apparatus 4, for example, when the coupon information is used by the user terminal 5 (for example, when the coupon information is displayed on the display unit 23), and is set in the behavior information history table.

Moreover, the behavior history of the behavior information history table illustrated in FIG. 6 includes information indicating a view by the user terminal 5, of the advertisement information corresponding to the place where the identification target 6 is provided. The information indicating a view of the advertisement information includes information on the content of the advertisement information and a view date. The information indicating a view of the advertisement information is information notified from the user terminal 5 or the site server 8 when the advertisement information is viewed by the user terminal 5 and is set in the behavior information history table.

1.4.3. User Information Extracting Unit 53

The user information extracting unit 53 determines whether or not to output the user information based on the behavior history of the user U of the user terminal 5 corresponding to the terminal ID included in the detection information acquired from the detection information acquiring unit 52.

Specifically, the user information extracting unit 53 extracts information on the behavior history corresponding to the terminal ID included in the detection information from the behavior information history table of the behavior history DB 42. The user information extracting unit 53 determines whether or not to provide the user information of the business operator corresponding to the place where the identification target 6 corresponding to the identification target information included in the detection information is provided based on the extracted behavior history information.

The user information extracting unit 53 may determine that the user information is to be output when an entering frequency, the number of times of entering, or an entering state of the user terminal 5 into the place where the identification target 6 corresponding to the identification target ID included in the detection information satisfies predetermined conditions, for example.

Moreover, the user information extracting unit 53 may determine that the user information is to be output when the usage state of the coupon information in the place where the identification target 6 corresponding to the identification target ID included in the detection information satisfies predetermined conditions. Further, the user information extracting unit 53 may determine that the user information is to be output when the view by the user U of the user terminal 5, of the advertisement information corresponding to the identification target 6 corresponding to the identification target ID included in the detection information satisfies predetermined conditions.

The user information extracting unit 53 may determine whether or not to output the user information only when the stay period and the radio field intensity in the user entering place satisfy predetermined conditions.

Moreover, the user information extracting unit 53 may determine whether or not to output the user information based on the information on the viewing state of a webpage of the site server 8 by the user terminal 5 and the user information stored in the partnership information DB 41 in addition to or instead of the behavior information history table as the behavior history of the user U.

When it is determined that the user information is to be output based on the detection information acquired from the detection information acquiring unit 52, the user information extracting unit 53 extracts the user information of the partner company C corresponding to the user entering place from the partnership information DB 41. Specifically, the user information extracting unit 53 specifies the store ID and the company ID of the partner company C corresponding to the place where the identification target 6 corresponding to the identification target ID included in the detection information is provided. The store ID and the company ID are specified based on the partner company information table stored in the partnership in DB 41.

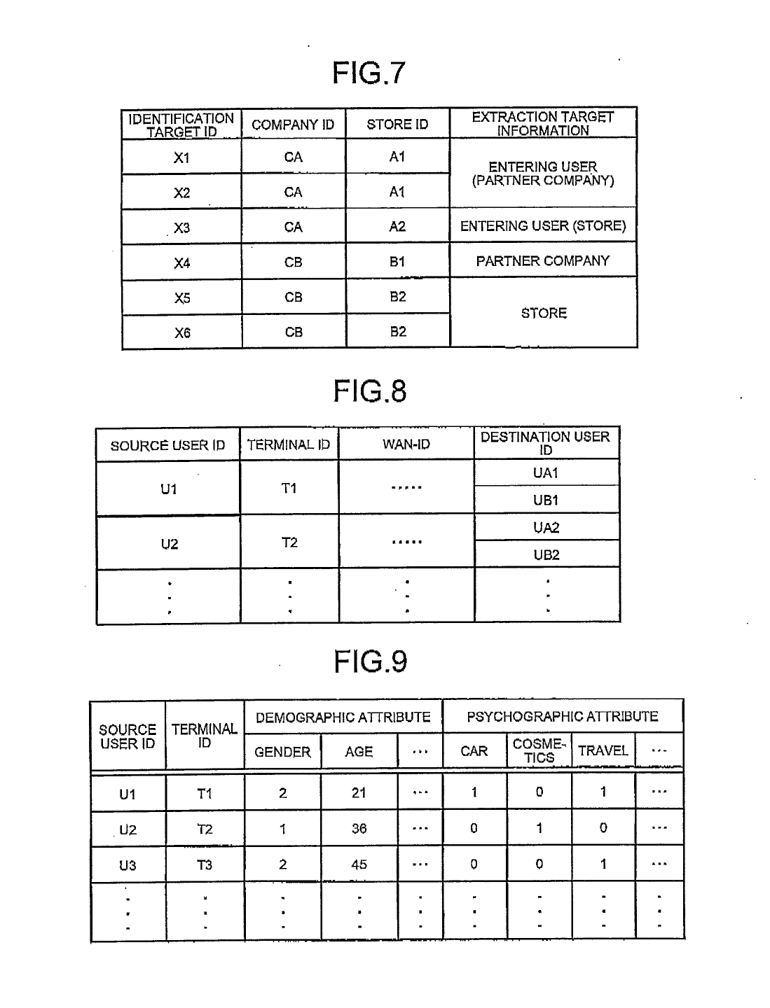

FIG. 7 is a diagram illustrating an example of the partner company information table. As illustrated in FIG. 7, the partner company information table includes information in which a “company ID,” a “store ID,” and “extraction target information” are associated with the “identification target ID”. For example, in the partner company information table illustrated in FIG. 7, the identification target IDs “X1” and “X2” are identification target IDs of the identification target 6 provided in the store A₁, and the identification target ID “X3” is the identification target ID of the identification target 6 provided in the store A₂.

Moreover, in the partner company information table illustrated in FIG. 7, the store IDs “A1” and “A2” of the stores A₁ and A₂ are associated with the company ID “CA,” and the store IDs “B1” and “B2” of the stores B₁ and B₂ are associated with the company ID “CB”. For example, when the identification target ID “X1” is included in the detection information, the user information extracting unit 53 specifies the partner company C corresponding to the user entering place has the company ID “CA” and the store ID “A1”.

Moreover, in the example illustrated in FIG. 7, an “entering user (partner company)” is associated with the store ID “A1,” an entering user (store)” is associated with the store ID “A₂,” a “partner company” is associated with the store ID “B1,” and a “store” is associated with the store ID “B2”.

The extraction target information “entering user (partner company)” is a setting that the user information of the partner company C into which the entering user U has entered among the items of user information of the entering user U is set as an extraction target to be extracted by the user information extracting unit 53. Moreover, the extraction target information “entering user (store)” is a setting that the user information of the store into which the entering user U has entered among the items of user information of the entering user U is set as an extraction target to be extracted by the user information extracting unit 53.

Moreover, the extraction target information “partner company” is a setting that all items of user information of the partner company C into which the entering user U has entered are set as an extraction target to be extracted by the user information extracting unit 53. Further, the extraction target information “store” is a setting that all items of user information of the store into which the entering user U has entered are set as an extraction target to be extracted by the user information extracting unit 53. The extraction target information is set in the partner company information table by the user information acquiring unit 51 in response to a request from the apparatus (for example, the information management apparatuses 4₁ and 4₂) of the partner company C, for example.

Moreover, when the extraction target information corresponding to the company ID and the store ID is “entering user (partner company)” or “entering user (store),” the user information extracting unit 53 specifies the user ID (destination user ID) of the partner company C corresponding to the user entering place based on the terminal ID included in the detection information. The user ID is specified based on the correspondence information table stored in the correspondence information DB 43.

FIG. 8 is a diagram illustrating an example of the correspondence information table. As illustrated in FIG. 8, the correspondence information table includes information in which a “terminal ID,” a “WAN-ID,” and a “destination user ID” are associated with a “source user ID”.

The “source user ID” is identification information of the user U set by the advertisement distributor, and for example, is a login ID of the site server 8. For example, when the terminal ID “T1” is included in the detection information, the user information extracting unit 53 determines that the destination user ID is “UA1” and “UB1,” and the source user ID is “U₁”. The destination user ID is the same as the destination user ID of the partner user information table.

The “WAN-ID” is information indicating the address of the second radio communication unit 21 of the user terminal 5, and it is possible to transmit information to the user terminal 5 using the WAN-ID as a destination address. Information may be transmitted to the user terminal 5 using the sender address of the detection information as a destination.

When the company ID and the store ID (and the destination user ID if necessary) are specified based on the detection information, the user information extracting unit 53 extracts the user information corresponding to the specified company ID from the partner user information table of the partnership information DB 41.

For example, it is assumed that the partner user information table is in the state illustrated in FIG. 5, and the company ID and the destination user ID specified by the user information extracting unit 53 are “CA” and “UA1,” respectively. In this case, the user information extracting unit 53 extracts visit information such as “2013/5/31 AM 7:24 to 7:32 Store A₁” and purchase history such as “2013/5/31 AM 7:30 Milk (Company A) Stare A₁” from the partner user information table as the user information.

Moreover, it is assumed that the company ID, the store ID, and the destination user ID specified by the user information extracting unit 53 are “CA,” “A2,” and “UA2,” respectively. In this case, the user information extracting unit 53 extracts user information such as visit information and purchase history that include the information on “Store A₂” among the items of user information corresponding to “UA2” from the partner user information table.

Further, it is assumed that the company ID and the store ID specified by the user information extracting unit 53 are “CB” and “B1,” respectively. In this case, the user information extracting unit 53 extracts all items of user information corresponding to the company ID “CB” from the partner user information table.

Further, it is assumed that the company ID and the store ID specified by the user information extracting unit 53 are “CB” and “B2,” respectively. In this case, the user information extracting unit 53 extracts visit information and purchase history that include “Store B₂” among the items of user information corresponding to the company ID “CB” from the partner user information table.

In this way, the user information extracting unit 53 extracts only the user information of the partner company C corresponding to the user entering place but does not extract the user information of partner companies other than the partner company C corresponding to the user entering place. Thus, it is possible to limit the access to the user information in respective partner companies C and to secure the security in respective partner companies C.

Moreover, when the user information of the entering user U among the items of user information of the partner company C corresponding to the user entering place is not present in the partnership information DB 41, the user information extracting unit 53 can acquire the corresponding user information from the user information table stored in the user information DB 44.

Moreover, even when the number of visit histories or the number of purchase histories included in the user information of the entering user U stored in the partnership information DB 41 is equal to or smaller than a predetermined number, the user information extracting unit 53 can acquire the corresponding user information from the user information table.

FIG. 9 is a diagram illustrating an example of the user information table. As illustrated in FIG. 9, information associated with a “terminal ID,” a “demographic attribute,” and a “psychographic attribute” is included in each “source user ID”. An access log to the site server 8 managed by the advertisement distributor may be further set in the user information table in association with the “source user ID”.

The source user ID” and the “terminal ID” are the same IDs as the “source user ID” and the “terminal ID” of the correspondence information table illustrated in FIG. 8. The “source user ID” may be user identification information set in the hypertext transfer protocol (HTTP) cookie transmitted between the site server 8 and the user terminal 5, for example, instead of the login ID of the site server 8.

The “demographic attribute” indicates demographic attribute information of the user U. The “demographic attribute” is classified into attribute classes such as the “gender” and the “age” of the user U, for example. “1” is stored in the “gender” when the user U is a female and “2” is store when the user U is a male. Moreover, the age of the user U is stored in the “age”. The “demographic attribute” is not limited to the example of the attribute classes illustrated in FIG. 9 but may include various attribute classes such as an occupation, a family structure, an annual income, an address, a birthplace, and an educational background of the user U.

The “psychographic attribute” is information indicating the values, the lifestyle, the character, the preference, and the like of the user U. The “psychographic attribute” is classified into attribute classes such as “car,” “cosmetics,” and “travel,” for example. In the example illustrated in FIG. 9, for each attribute class, “1” is stored when the preference of the user U is relatively high, and otherwise, “0” is stored. Moreover, the “psychographic attribute” is not limited to the example of the attribute classes illustrated in FIG. 9, but may include various attribute classes such as economy, politics, baseball, soccer, other sports, sweets, personal computers, household electrical appliances, and furniture.

When the user information of the partner company C corresponding to the user entering place is acquired, the user information extracting unit 53 adds the source user ID of the entering user U and the company ID and the store ID corresponding to the entering place to the user information as additional information and outputs the user information to the user information output unit 54.

For example, when the user U₁ of the user terminal 5₁ having the terminal ID “T1” enters into the store A₁ of the partner company CA, the source user ID “U1,” the company ID “CA,” and the store ID “A1” are added to the user information of the company ID “CA” as additional information and are output to the user information output unit 54.

1.4.4. User Information Output Unit 54

When the user information to which the additional information is added is acquired from the user information extracting unit 53, the user information output unit 54 outputs the user information to the advertisement distribution apparatus 3 via the communication unit 30 and the communication network 9. The user information output unit 54 may not be provided, and the user information extracting unit 53 may output the user information to which the additional information is added to the advertisement distribution apparatus 3.

1.5. Advertisement Distribution Apparatus 3

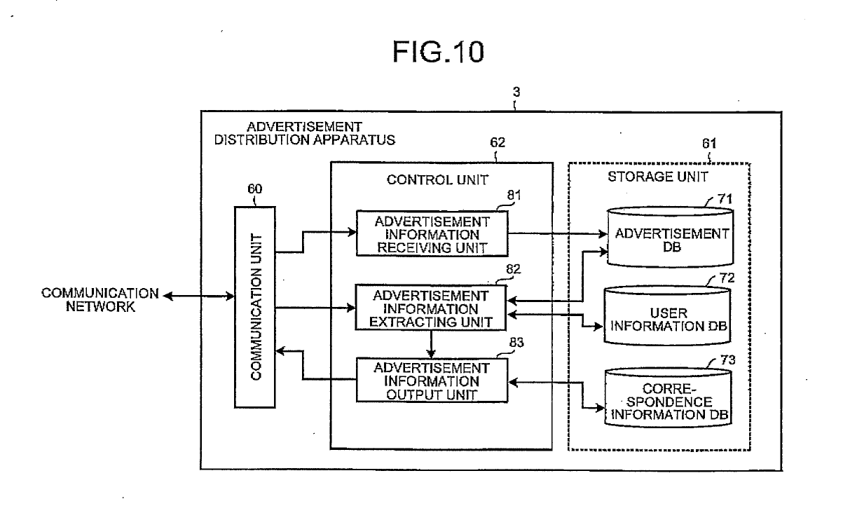

Next, the configuration of the advertisement distribution apparatus 3 will be described in detail. FIG. 10 is a diagram illustrating an example of the configuration of the advertisement distribution apparatus 3. As illustrated in FIG. 10, the advertisement distribution apparatus 3 includes a communication unit 60, a storage unit 61, and a control unit 62. Further, the storage unit 61 includes an advertisement DB 71, a user information DB 72, and a correspondence information DB 73, and the control unit 62 includes an advertisement information receiving unit 81, an advertisement information extracting unit 82, and an advertisement information output unit 83.

The communication unit 60 is an interface such as a NIC. The control unit 62 can transmit and receive various items of information to and from the user information providing apparatus 2, the information management apparatus 4, the user terminal 5, and the site server 8 via the communication unit 60 and the communication network 9. The advertisement DB 71, the user information DB 72, and the correspondence information DB 73 are semiconductor memory devices such as RAM or flash memory or storage devices such as a hard disk, for example.

The control unit 62 functions as an advertisement information receiving unit 81, an advertisement information extracting unit 82, and an advertisement information output unit 83 when an internal CPU or MPU executes the program stored in an internal storage device using RAM as a work area. The control unit 62 is not limited to this configuration but may have another configuration as long as the control unit 62 can perform the information processing described later.

1.5.1. Advertisement Information Receiving Unit 81

The advertisement information receiving unit 81 receives posting information of an advertisement from the advertiser terminal 7. The posting information includes distribution conditions such as a distribution destination and the number of distributions and information on the advertisement information of a distribution target. Upon receiving the advertisement posting information, the advertisement information receiving unit 81 sets the received posting information in the advertisement information table of the advertisement DB 71.

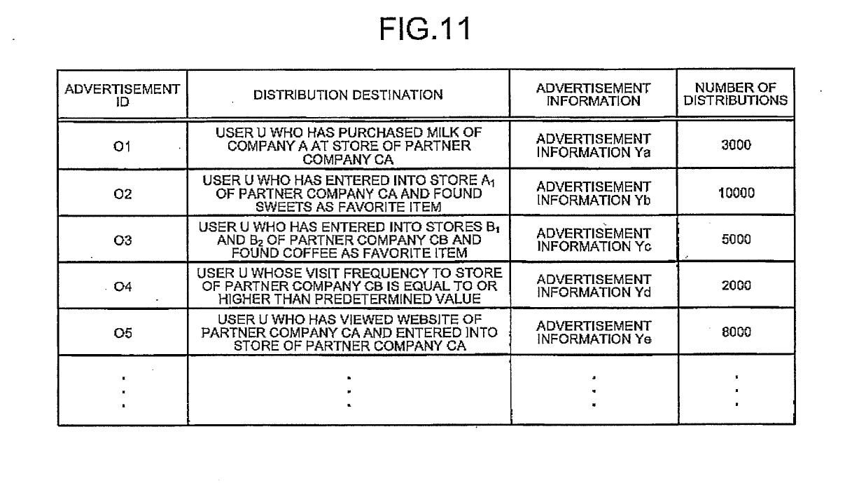

FIG. 11 is a diagram illustrating an example of the advertisement information table. As illustrated in FIG. 11, the advertisement information table includes information it which a “distribution destination,” “advertisement information,” and the “number of distributions” are associated with the “advertisement ID”.

The “advertisement ID” is identification information allocated to each posting information received and is allocated by the advertisement information receiving unit 81. The “distribution destination” is conditions for the distribution destination designated in the posting information. The “advertisement information” is advertisement information of a distribution target, and examples thereof include a text advertisement, a still image advertisement, a moving picture advertisement, an animation advertisement, and a banner advertisement. The advertisement information includes link information for acquiring raw image materials and program codes for displaying advertisements as well as the raw image materials and program codes.

The “number of distributions” is the number of distributions of the advertisement information designated in the posting information. Although the advertisement information table includes distribution conditions such as a distribution period designated in the posting information, the distribution conditions are not illustrated in the example illustrated in FIG. 11.

Moreover, as illustrated in FIG. 11, in the advertisement information table, an “entering user U who has entered into the store of the partner company C and found a predetermined item as a favorite item,” a “user U who has purchased a predetermined item in the store of the partner company C,” a “user U whose frequency of visiting a predetermined store of the partner company C is equal to or larger than a predetermined value,” and the like can be set as the conditions for the “distribution destination”. Moreover, in the advertisement information table, a “user U who has viewed a website of the partner company C” and the like can be set as the “distribution destination”.

1.5.2. Advertisement Information Extracting Unit 82

The advertisement information extracting unit 82 acquires the user information to which the additional information is added from the user information providing apparatus 2 via the communication network 9 and the communication unit 60 and extracts advertisement information corresponding to the user information from the advertisement information table of the advertisement DB 71.

The advertisement information extracting unit 62 outputs the advertisement information extracted from the advertisement information table based on the user information to the advertisement information output unit 83. Moreover, the advertisement information extracting unit 82 also outputs the additional information acquired from the user information providing apparatus 2 to the advertisement information output unit 83.

Here, for example, it is assumed that the partner user information table is in the state illustrated in FIG. 5 and the advertisement information table is in the state illustrated in FIG. 11. When the user information acquired from the user information providing apparatus 2 is the user information of the destination user ID “UA1,” since the purchase history of “Milk (Company A)” is included in the user information, the advertisement information extracting unit 82 extracts “advertisement information Ya” of the advertisement ID “O1,” for example, from the advertisement information table.

Moreover, for example, when the favorite item of the entering user U specified from the purchase history of the user information is “Sweets,” and the company ID and the store ID included in the additional information are “CA” and “A1,” respectively, the advertisement information extracting unit 82 extracts “advertisement information Yb” of the advertisement ID “O2,” for example, from the advertisement information table.

Further, for example, when the favorite item of the entering user U specified from the purchase history of the user information is “Coffee,” and the company ID and the store ID included in the additional information are “CB” and “B1” or “B2,” respectively, the advertisement information extracting unit 82 extracts “advertisement information Yc” of the advertisement ID “O3,” for example, from the advertisement information table.

Further, for example, when the visit frequency of the entering user U to the store of the partner company CB determined from the visit history of the user information is equal to or larger than a predetermined value, the advertisement information extracting unit 82 extracts “advertisement information Yd” of the advertisement ID “O4,” for example, from the advertisement information table.

Further, when the user information acquired from the user information providing apparatus 2 is all items of user information of the partner company C corresponding to the place to which the entering user U has entered or the user information of the store to which the entering user U has entered, the advertisement information is extracted from the advertisement information table based on these items of user information.

For example, the advertisement information extracting unit 82 determines an operation state of the partner company C from the user information acquired from the user information providing apparatus 2 and extracts advertisement information associated with the determined operation state from the advertisement information table. Examples of the operation state of the partner company C determined by the advertisement information extracting unit 82 includes a business category of the partner company C, the type, the content, and the amount of items and services provided by the partner company C, and the like.

In this manner, since the advertisement information extracting unit 82 can select advertisement information based on the user information of the partner company C, it is possible to narrow the users U associated with the partner company C down to an advertisement distribution target. In this way, it is possible to perform highly accurate targeting advertising.

Moreover, when it is not possible to select advertisement information based on the user information acquired from the user information providing apparatus 2, the advertisement information extracting unit 82 may select the advertisement information based on the additional information. In this case, the advertisement information extracting unit 82 acquires the user information corresponding to the source user ID included in the additional information from the user information table of the user information DB 72 and use the user information, for example. The user information table of the user information DB 72 is the same information as the user information table of the user information providing apparatus 2, for example.

The advertisement information extracting unit 82 can specify the partner company C having the store that the user U has entered based on the company ID included in the additional information and can specify the store that the user U has entered based on the store ID included in the additional information. Moreover, the advertisement information extracting unit 82 can specify the attribute of the entering user U based on the user information table of the user information DB 72 and can specify the preference, the behavior, and the like of the user based on the access log to sites.

Thus, when it is determined that the entering user U is the entering user U who has viewed a website of the partner company CA provided by the site server 8 and has entered into the store of the partner company CA, for example, based on the additional information and the user information of the user information DB 72, the advertisement information extracting unit 82 extracts “advertisement information Ye” of the advertisement ID “O5” from the advertisement information table.

Moreover, when an advertisement information transmission request including a designated source user ID is received from the site server 8, the advertisement information extracting unit 82 acquires the user information corresponding to the source user ID from the user information table of the user information DB 72 and extracts the advertisement information corresponding to the user information from the advertisement DB 71. For example, when it is determined that the user U of the source user ID has a relatively high preference for “Car” based on the user information corresponding to the source user ID, for example, the advertisement information extracting unit 82 extracts advertisement information corresponding to distribution conditions that designate the user U having relatively high preference for “Car” from the advertisement DB 71.

1.5.3. Advertisement Information Output Unit 83

The advertisement information output unit 83 outputs the advertisement information extracted by the advertisement information extracting unit 82 to the user terminal 5 having entered into the place corresponding to the partner company C via the communication network 9.

When the user terminal 5 accesses the site server 8 the advertisement information and the source user ID can be also transmitted to the site server 8 so that the advertisement information is embedded in an access destination page. In this case, the site server 8 embeds the advertisement information acquired from the advertisement distribution apparatus 3 with respect to the user terminal 5 having logged in with the source user ID in the access destination page and transmits the advertisement information to the user terminal 5.

Moreover, when an email address of the user terminal 5 having entered into the place corresponding to the partner company C is set in the correspondence information table, the advertisement information may be output to the user terminal 5 via an email.

1.6. Process of Advertisement Distribution System 1

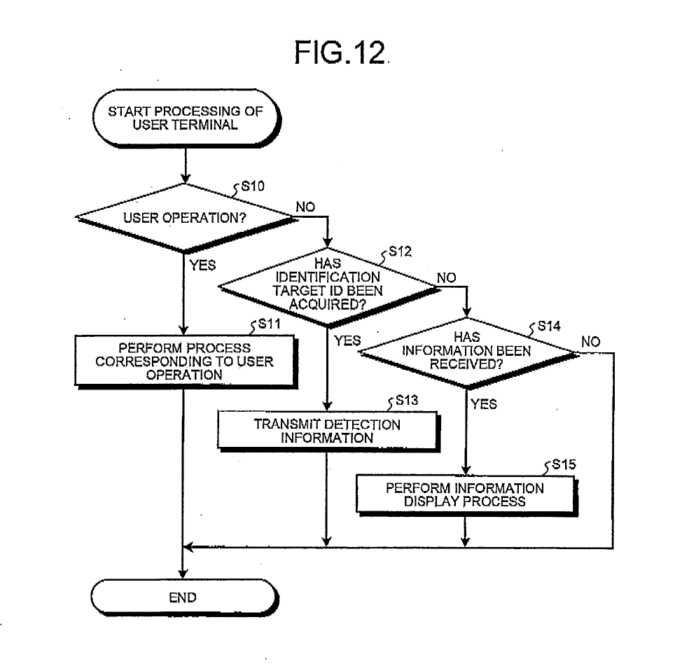

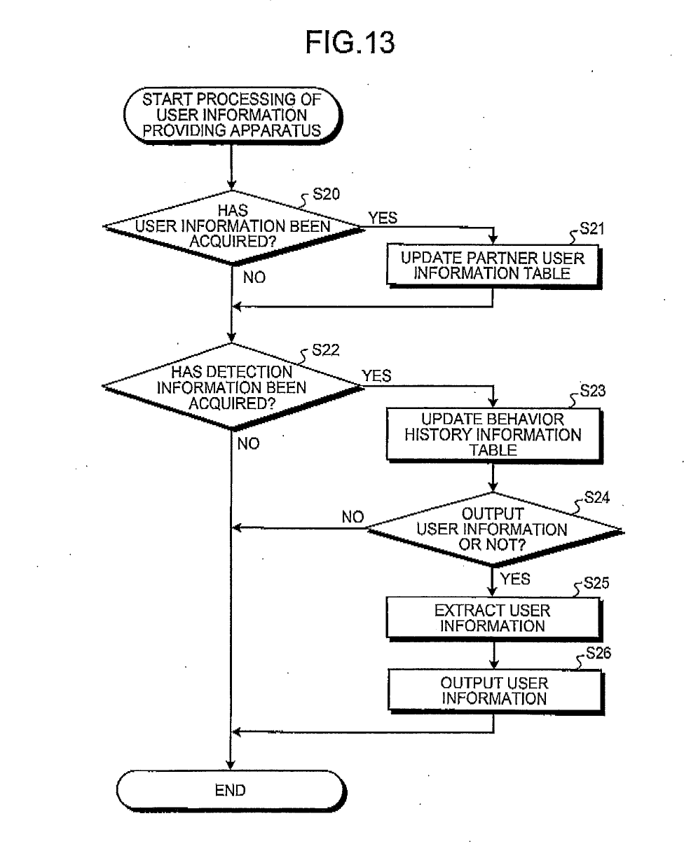

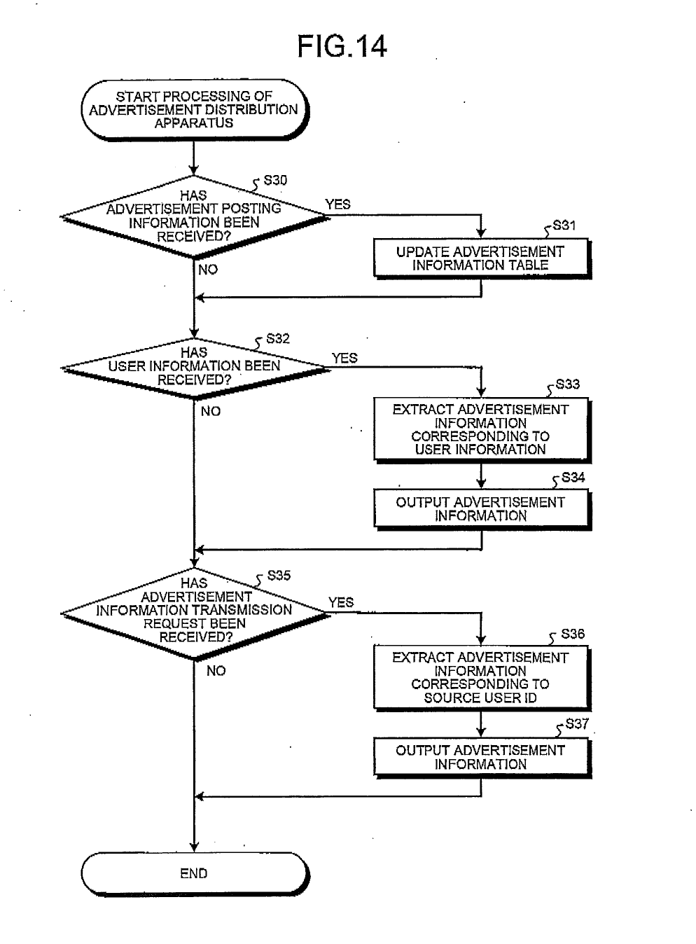

Next, the flow of the information providing process of the advertisement distribution system 1 according to the embodiment will be described. FIGS. 12 to 14 are diagrams for describing the flow of the information providing process of the advertisement distribution system 1. In the following description, the information processing of the user terminal 5 will be described with reference to FIG. 12, the information processing of the user information providing apparatus 2 will be described with reference to FIG. 13, and the information processing of the advertisement distribution apparatus 3 will be described with reference to FIG. 14.

1.6.1. Process of User Terminal 5

First, the information processing of the user terminal 5 according to the embodiment will be described. FIG. 12 is a flowchart illustrating an example of the information processing of the user terminal 5 according to the embodiment. The operation is a process repeatedly executed by the control unit 26 of the user terminal 5.

As illustrated in FIG. 13, the control unit 26 of the user terminal 5 determines whether a user operation has been received (step S10). When it is determined that the user operation has been received (step S10: Yes), a process based on the user operation is performed (step S11). For example, when the user operation requests displaying the coupon information stored in the storage unit 25, the coupon information is extracted from the storage unit 25 and displayed on the display unit 23, and whether or not to use the coupon information is determined and the determination result is transmitted to the user information providing apparatus 2.

When it is determined that the user operation has not been received (step S10: No), the control unit 26 determines whether an identification target ID has been acquired from the identification target 6 (step S12). When it is determined that the identification target ID has been acquired (step S12: Yes), the control unit 26 transmits detection information including the acquired identification target ID and the terminal ID to the user information providing apparatus 2 (step S13).

When it is determined that the identification target ID has not been acquired (step S12: No), the control unit 26 determines whether information has been received from the information management apparatus 4 or the site server 8 (step S14). When it is determined that information has been received (step S14: Yes), the control unit 26 displays the received information on the display unit 23 and stores the same in the storage unit 25 (step S15).

When the process of steps S11, S13, and S15 ends or when it is determined in step S14 that information has not been received (step S14: No), the control unit 26 ends the process.

1.6.2. Process of User Information Providing Apparatus 2

Next, the information processing of the user information providing apparatus 2 will be described. FIG. 13 is a flowchart illustrating the information processing of the user information providing apparatus 2 according to the embodiment. The operations is a process repeatedly executed by the control unit 32 of the user information providing apparatus 2.

As illustrated in FIG. 13, the control unit 32 determines whether user information of the partner company C has been acquired from the information management apparatus 4 via the communication unit 30 (step S20). When it is determined that the user information of the partner company C has been acquired (step S20: Yes), the control unit 32 sets the acquired user information in the partner user information table of the partnership information DB 41 and updates the partner user information table (step S21).

Subsequently, when it is determined in step S20 that the user information of the partner company C has not been acquired (step S20: No), or when the process of step S21 ends, the control unit 32 determines whether detection information transmitted from the user terminal 5 has been acquired via the communication unit 30 (step S22). When it is determined that the detection information has been acquired (step S22: Yes), the control unit 32 updates the behavior information history table based on the acquired detection information (step S23).

Subsequently, the control unit 32 determines whether or not to output the user information based on the updated behavior information history table and the like (step S24). When it is determined that the user information is to be output (step S24: Yes), the control unit 32 extracts the user information of the partner company C corresponding to the user entering place from the partnership information DB 41 based on the detection information (step S25). Moreover, the control unit 32 outputs the user information of the partner company C extracted in step S25 to the advertisement distribution apparatus 3 (step S26). Additional information is added to the user information.

When it is determined that the detection information has not been acquired (step S22: No), when it is determined that the user information is not to be output (step S24: No), or when the process of step S26 ends, the control unit 32 ends the process.

1.6.3. Process of Advertisement Distribution Apparatus 3

Next, the information processing of the advertisement distribution apparatus 3 will be described. FIG. 14 is a flowchart illustrating the information processing of the advertisement distribution apparatus 3 according to the embodiment. The operation is a process repeatedly executed by the control unit 62 of the advertisement distribution apparatus 3.

As illustrated in FIG. 14, the control unit 62 determines whether advertisement posting information has been received from the apparatus of the advertiser via the communication unit 60 (step S30). When it is determined that the advertisement posting information has been received (step S30: Yes), the control unit 62 sets the posting information in the advertisement information table of the advertisement DB 71 (step S31).

When it is determined that the advertisement posting information has not been received (step S30: No), or when the process of step S31 ends, the control unit 62 determines whether the user information to which the additional information is added has been acquired from the user information providing apparatus 2 (step S32). When it is determined that the user information has been acquired (step S32: Yes), the control unit 62 extracts the advertisement information corresponding to the acquired user information from the advertisement DB 71 (step S33) and outputs the extracted advertisement information to the user terminal 5 (step S34).

When it is determined that the user information has not been acquired (step S32: No), or the process of step S34 ends, the control unit 62 determines whether an advertisement information transmission request including a designated source user ID has been received from the site server 8 (step S35). When it is determined that the advertisement information transmission request has been received (step S35: Yes), the control unit 62 acquires the user information corresponding to the source user ID included in the transmission request from the user information DB 72 and extracts the advertisement information corresponding to the user information from the advertisement DB 71 (step S36).

Moreover, the control unit 62 outputs the advertisement information extracted from the advertisement DB 71 to the site server B (step S37). When it is determined that the advertisement information transmission request has not been received (step S35: No), or when the process of step S37 ends, the control unit 62 ends the process.

### 2. Second Embodiment

Next, an advertisement distribution system according to a second embodiment will be described. In the advertisement distribution system 1 according to the first embodiment, whether or not to output the user information is determined based on the behavior history of the user U. However, in the advertisement distribution system according to the second embodiment, a list corresponding to the behavior history of the user U is generated and whether or not to output the user information is determined based on the list.

The advertisement distribution system according to the second embodiment has approximately the same configuration as the advertisement distribution system 1 according to the first embodiment, except that the user information providing apparatus has a partially different configuration. In the following description, the same constituent components as the user information providing apparatus 2 according to the first embodiment will be denoted by the same reference numerals and description thereof will not be provided appropriately.

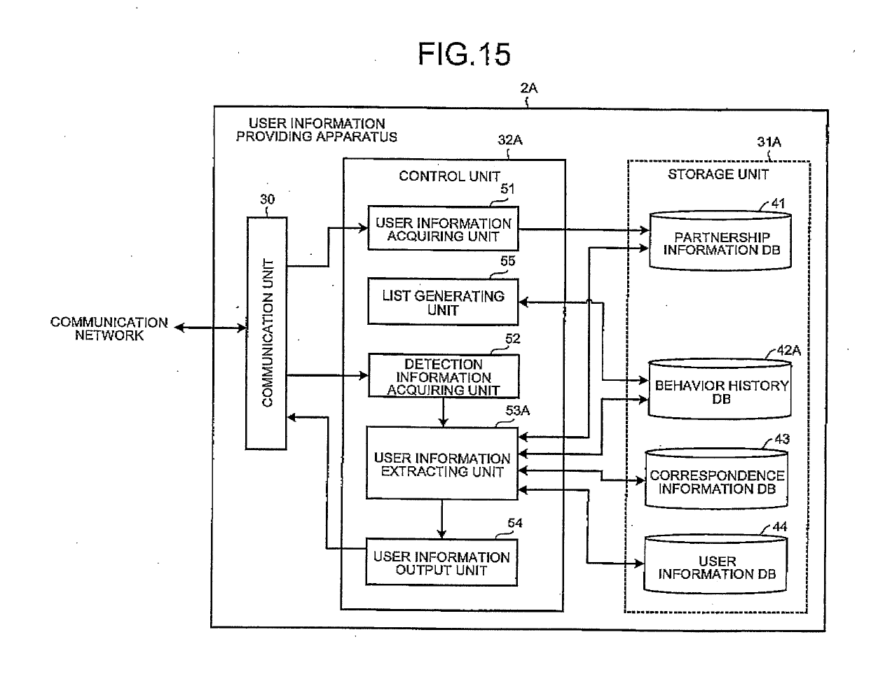

FIG. 15 is a diagram illustrating a configuration example of a user information providing apparatus according to the second embodiment. As illustrated in FIG. 15, a user information providing apparatus 2A according to the second embodiment includes a communication unit 30, a storage unit 31A, and a control unit 32A.

The storage unit 31A includes a partnership information DE 41, a behavior history DB 42A, a correspondence information DB 43, and a user information DB 44. Moreover, the control unit 32A includes a user information acquiring unit 51, a detection information acquiring unit 52, a user information extracting unit 53A, a user information output unit 54, and a list generating unit 55.

2.1. List Generating Unit 55

First the list generating unit 55 will be described. The list generating unit 55 generates and updates an identification target list corresponding to the behavior history of the user U of a user terminal 5 based on the behavior history information table stored in the behavior history DB 42A and the like.

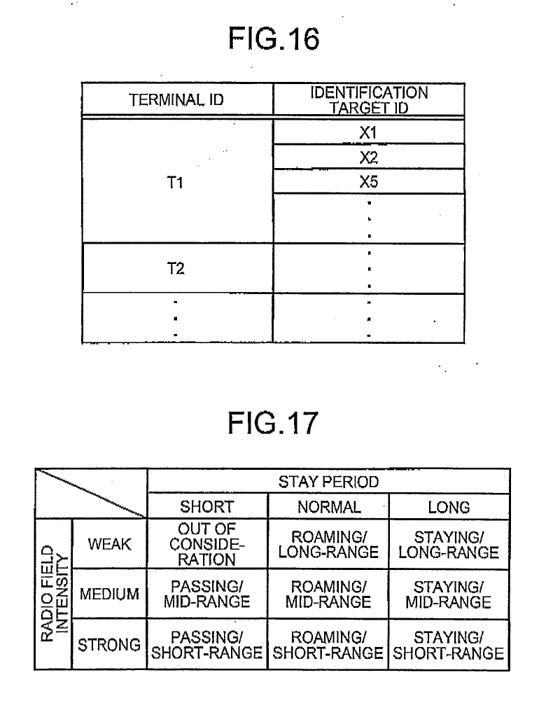

FIG. 16 is a diagram illustrating an example of the identification target list stored in the behavior history DB 42A. As illustrated in FIG. 16, the identification target list is information in which a “terminal ID” and an “identification target ID” are associated. The “identification target ID” included in the identification target list is an identification target ID of an identification target 6 provided in the place corresponding to the behavior of the user U having the user terminal 5 of the corresponding “terminal ID”.

Examples of the place corresponding to the behavior of the user U include, for example, a place that the user U often visits, a favorite place of the user U determined from the behavior (for example, usage of the coupon information and viewing of the advertisement information) of the user U and a suggested place of the user U determined from the behavior of the user U.

The list generating unit 55 analyzes the behavior of the user U based on the behavior history information table stored in the behavior history DB 42A, determines a store that the user U often visits, a favorite store, and the like, and generates and updates the identification target list based on the determination result.

Specifically, the list generating unit 55 determines the usage result of the coupon information by the user, an access result of the advertisement information, an acquisition state of the identification target 6, and the like based on the behavior history information table, determines the place corresponding to the behavior of the user U such as a place that the user U often visits, a favorite place of the user U, and a suggested place of the user U, and generates and updates the identification target list.

For example, the list generating unit 55 adds the identification target ID of the identification target 6 corresponding to the place where the coupon information is used by the user U to the identification target list. Moreover, the list generating unit 55 may delete the identification target ID of the identification target 6 corresponding to the place where the coupon information was not used by the user U from, the identification target list.

Moreover, for example, the list generating unit 55 adds the identification target ID of the identification target 6 corresponding to the place corresponding to the advertisement information viewed by the user U to the identification target list. Further, the list generating unit 55 may delete the identification target ID of the identification target 6 corresponding to the place corresponding to the advertisement information which was not viewed by the user U from the identification target list.

Moreover, for example, the list generating unit 55 adds the identification target ID of the identification target 6 in which an entering frequency, the number of times of entering, or an entering state of the user terminal 5 to the place corresponding to the identification target 6 satisfies predetermined conditions to the identification target list.

Specifically, the list generating unit 55 adds the identification target ID of the identification target 6 in which the detection frequency or the number of times of detection of the user terminal 5 is equal to or larger than a threshold to the identification target list. Moreover, when the identification target 6 is a radio communication device, the list generating unit 55 extracts a stay period and a radio field intensity of the user terminal 5 in a radio communication area of the identification target 6 from the behavior history information table and determines the type of an entering state of the user terminal 5 into the radio communication area.

The list generating unit 55 determines the type of the entering state based on a stay state determination table, for example. FIG. 17 is a diagram illustrating an example of the stay state determination table stored in the behavior history DB 42A. The stay state determination table is a table in which the length of the stay period and the strength of the radio field intensity are associated with the type of a stay state.

In the stay state determination table illustrated in FIG. 17, the types of stay states include “passing/mid-range,” “passing/short-range,” “roaming/long-range,” “roaming/mid-range,” “roaming/short-range,” “staying/long-range,” “staying/mid-range,” and “staying/short-range”. The types of stay states illustrated in FIG. 17 are examples, and the stay state determination table may be set based on other classes.

In the stay state determination table, “Short” indicates a case where the stay period is between a first threshold period and a second threshold period, “Normal” indicates a case where the stay period is between the second threshold period and a third threshold period, and “Long” indicates a case where the sheet conveying path is equal to or longer than the third threshold period.

Moreover, in the stay state determination table, “Weak” indicates a case where the radio field intensity is between a first threshold intensity and a second threshold intensity, “Medium” indicates a case where the radio field intensity is between the second threshold intensity and a third threshold intensity, and “Strong” indicates a case where the radio field intensity is equal to or larger than the third threshold intensity. In this example, although the “stay period” and the “radio field intensity” are classified into three states, the same may be classified into two or four or more states.

Here, it is assumed that the conditions for adding targets to the identification target list are set such that the “stay state” is “staying/short-range” and “staying/mid-range,” and the “number of times of entering” is “three times”. In this case, the list generating unit 55 adds the identification target ID of the identification target 6 in which the state of “staying/near-range” or “staying/mid-range” is detected at least “three times” to the identification target list.

Moreover, it is also assumed that the conditions for adding targets to the identification target list are set such that the “stay state” is “roaming/long-range,” “roaming/mid-range,” and “roaming/short-range” and the “entering frequency” is “twice/week”. In this case, the list generating unit 55 adds the identification target ID of the identification target 6 in which the state of “roaming/long-range,” “roaming/mid-range,” and “roaming/short-range” and the “entering frequency” is detected with the frequency of “twice/week” or more to the identification target list.

In this way, the list generating unit 55 determines the identification target ID corresponding to the output target user information and adds the same to the identification target list. In the user information extracting unit 53 of the user information providing apparatus 2 according to the first embodiment, the identification target ID corresponding to the output target user information may be determined by the same method as that used by the list generating unit 55.

2.2. User Information Extracting Unit 53A

The user information extracting unit 53A determines that the user information is to be output when a combination of the identification target ID and the terminal ID included in the detection information acquired from the detection information acquiring unit 52 is included in the identification target list. For example, when the terminal ID included in the detection information is “T1” and the identification information ID is “X1,” the user information extracting unit 53A determines that the user information is to be output.

When it is determined that the user information is to be output, the user information extracting unit 53A extracts the user information of the partner company C corresponding to the user entering place from the partnership information DB 41 similarly to the user information extracting unit 53.

In this manner, the user information providing apparatus 2A according to the second embodiment generates an identification target list for determining whether or not to output the user information in advance. Due to this, the user information providing apparatus 2A can quickly determine whether or not to output the user information.

### 3. Third Embodiment

Next, an advertisement distribution system according to a third embodiment will be described. In the first and second embodiments, the user information providing apparatuses 2 and 2A have determined whether or not to output the user information based on the behavior history of the user U. However, in the third embodiment, the user terminal determines the same based on the behavior history of the user U.

An advertisement distribution system according to the third embodiment has approximately the same configuration as the advertisement distribution system according to the second embodiment except that the user information providing apparatus and the user terminal have partially different configurations. In the following description, the same constituent components as those of the user information providing apparatus 2A and the user terminal 5 according to the second embodiment will be denoted by the same reference numerals, and description thereof will not be provided appropriately.

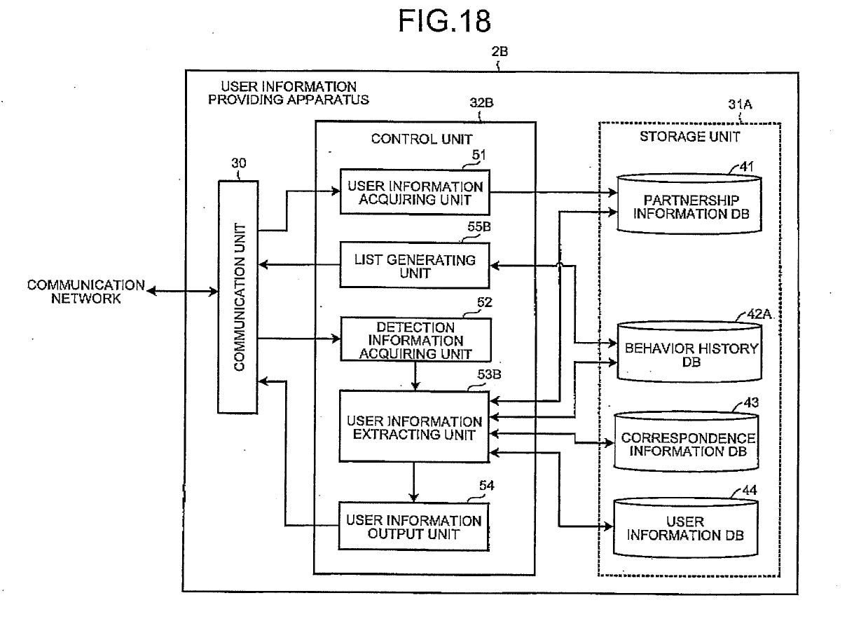

FIG. 18 is a diagram illustrating a configuration example of the user information providing apparatus according to the third embodiment. As illustrated in FIG. 18, a user information providing apparatus 2B according to the third embodiment includes a communication unit 30, a storage unit 31A, and a control unit 32B.

The control unit 32B includes a user information acquiring unit 51, a detection information acquiring unit 52, a user information extracting unit 53B, a user information output unit 54, and a list generating unit 55B.

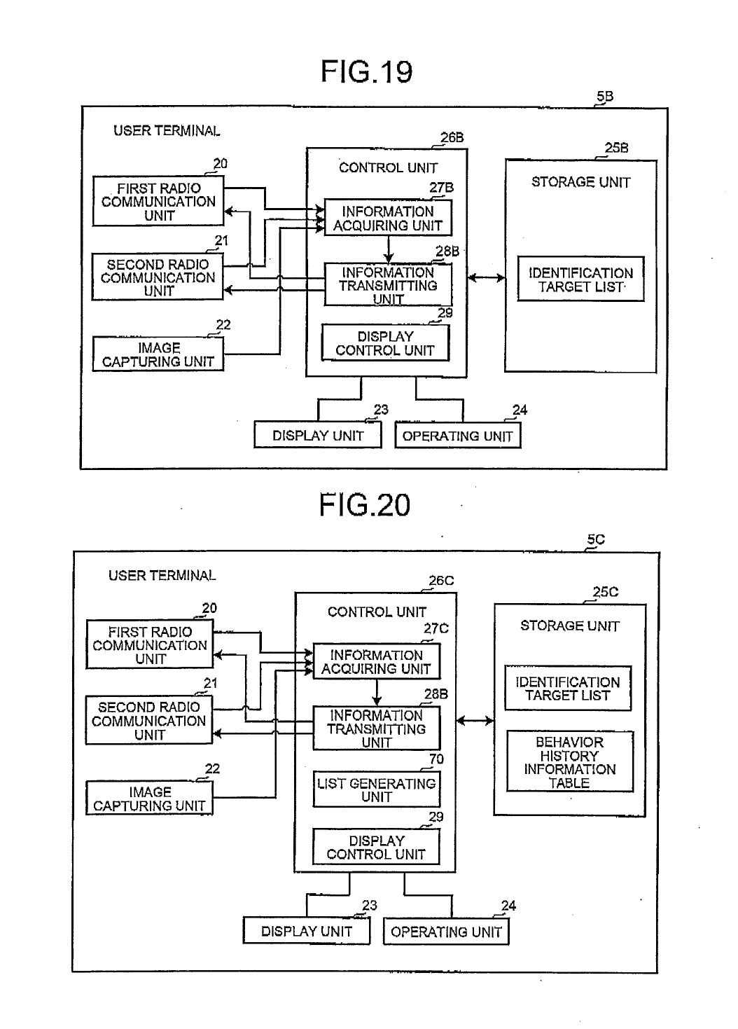

The list generating unit 55B generates and updates an identification target list corresponding to the behavior history of the user U of the user terminal 5B (see FIG. 19) based on the behavior history information table stored in the behavior history DB 42A and the like similarly to the list generating unit 55.

Further, the list generating unit 55B transmits the corresponding information among the items of information of the generated identification target list to the user terminal 5B. For example, when the identification target list is in the state illustrated in FIG. 16, an identification target list in which the identification target IDs “X1,” “X2,” “X5,” and the like are included for a user terminal 5B of the terminal ID “T1” is transmitted to the user terminal 5B. In this way, the identification target lists corresponding to the behavior histories of the users U of the user terminals 5B are acquired by the respective user terminals 5B.

The user information extracting unit 53B determines that the user information is to be output when the detection information has been acquired by the detection information acquiring unit 52. When it is determined that the user information is to be output, the user information extracting unit 53B extracts the user information of the partner company C corresponding to the user entering place from the partnership information DB 41 similarly to the user information extracting unit 53.

FIG. 19 is a diagram illustrating a configuration example of the user terminal 5B according to the third embodiment. In the user terminal 5B illustrated in FIG. 19, the information stored in a storage unit 25B and the process of a control unit 26B are partially different from the information stored in the storage unit 25 of the user terminal 5 and the process of the control unit 26. Various functions of the control unit 26B are executed by execution of an information notification card application stored in the storage unit 25B similarly to the control unit 26.

The control unit 26B includes an information acquiring unit 27B, an information transmitting unit 28B, and a display control unit 29. The information acquiring unit 27B has a function of acquiring the identification target list from the user information providing apparatus 2B via a first radio communication unit 20 or a second radio communication unit 21 in addition to the functions of the information acquiring unit 27. The information acquiring unit 27B stores the acquired identification target list in the storage unit 25B.

The information transmitting unit 28B determines whether the identification target ID acquired by the information acquiring unit 27B is included in the identification target list stored in the storage unit 25B. The information transmitting unit 28B transmits the detection information including the identification target ID and the terminal ID to the user information providing apparatus 2B via the first radio communication unit 20 or the second radio communication unit 21 similarly to the information transmitting unit 28.

In this manner, in the advertisement distribution system according to the third embodiment, since the user terminal 5B selects the identification target ID corresponding to the output target user information, it is possible to mitigate the processing load of the user information providing apparatus 2B.

### 4. Fourth Embodiment

Next, an advertisement distribution system according to a fourth embodiment will be described. In the third embodiment, the user information providing apparatus 2B generates the identification target list used by the user terminal 5B. However, in the fourth embodiment, the user terminal generates the identification target list.

The advertisement distribution system according to the fourth embodiment has approximately the same configuration as the advertisement distribution system according to the third embodiment except that the user information providing apparatus and the user terminal have partially different configurations. A user information providing apparatus 2C (not illustrated) according to the fourth embodiment has the same configuration as the user information providing apparatus 2B except that the user information providing apparatus 2C does not include the list generating unit 55B. In the following description, the same constituent components as those of the user terminal 5B according to the third embodiment will be denoted by the same reference numerals and description thereof will not be provided appropriately.

FIG. 20 is a diagram illustrating a configuration example of a user terminal 5C according to the fourth embodiment. In the user terminal 5C illustrated in FIG. 20; the information stored in a storage unit 25C and the process of a control unit 26C are partially different from the information stored in the storage unit 25B of the user terminal 5B and the process of the control unit 26B. Various functions of the control unit 26C are executed by execution of an information notification card application stored in the storage unit 25C similarly to the control unit 26.

The storage unit 25C stores a behavior history information table in addition to the information stored in the storage unit 25B. The behavior history information table is a table in which a target ID and a behavior history are associated, and is the corresponding information on the terminal ID within the behavior history information table illustrated in FIG. 6.

The control unit 26C includes an information acquiring unit 27C, an information transmitting unit 28B, a list generating unit 70, and a display control unit 29. The information acquiring unit 27C has a function of generating and updating the behavior history information table in addition to the functions of the information acquiring unit 27. Specifically, the information acquiring unit 27C stores the identification target ID acquired by the information acquiring unit 27C, a usage history of the coupon information by a user terminal 5C, a viewing history of the advertisement information by the user terminal 5C, and the like in the storage unit 25C and generates and updates the behavior history information table.

The list generating unit 70 generates the identification target list based on the behavior history information table and stores the generated identification target list in the storage unit 25C similarly to the list generating unit 55. The information transmitting unit 28B transmits the detection information including the identification target ID and the terminal ID to the user information providing apparatus 2C when the identification target ID acquired by the information acquiring unit 27C is included in the identification target list stored in the storage unit 25C.

In this manner, in the advertisement distribution system according to the fourth embodiment, since the user terminal 5C generates the identification target list and selects the identification target ID corresponding to the output target user information, it is possible to further mitigate the processing load of the user information providing apparatus 2C.

### 5. Modification

The advertisement information receiving unit 81 of the advertisement distribution apparatus 3 can receive the posting information if the advertiser is the partner company C only when the distribution conditions for the distribution destination designated in the posting information from the advertiser terminal 7 designate the user U associated with the partner company C.

For example, the posting information of the advertisement information that designates the “entering user U who has entered into the store of the partner company CA and found a predetermined item as a favorite item” as a distribution destination may be received by the advertisement information receiving unit 81 when the advertiser is the partner company CA only. Moreover, the posting information of the advertisement information that designates the “user U having viewed the website of the partner company CA” as a distribution destination may be received by the advertisement information receiving unit 81 when the advertiser is the partner company CA only.

Moreover, the advertisement information receiving unit 81 can receive the posting information when the advertiser is a partner company C that has signed a mutual usage contract. For example, when the partner companies CA and CB have signed a mutual usage contract, corresponding information is stored in the advertisement DB 71 as mutual usage information. When the advertisement information designates the user U associated with the partner company CA, for example, the advertisement information receiving unit 81 can receive the posting information based on the mutual usage information of the advertisement DB 71 when the advertiser is the partner company CA or the partner company CB only.

Moreover, the advertiser may be limited for each partner company C, for example. For example, when the advertiser is the manufacturing companies A and 8, the partner company CA can receive the posting information that designates the user U associated with the partner company CA. Advertiser limiting information of each partner company C is stored in the advertisement DB 71. When the advertisement information designates the user U associated with the partner company CA, for example, the advertisement information receiving unit 81 can receive the posting information based on the advertiser limiting information of the advertisement DB 71 when the advertise: is the partner company CA or the manufacturing companies A and B only.

Moreover, the partner companies C that have signed a mutual usage contract may use the user information. For example, when the partner companies CA and CB have signed a mutual usage contract, the advertisement information extracting unit 82 can extract the user information of the partner company CB based on the mutual usage information of the advertisement DB 71 when the user information of the partner company CA is not present, for example. Moreover, even when the user information of the partner company CA is present, the advertisement information extracting unit 82 can extract the user information of the partner company CA and the user information of the partner company CB as one item of user information.

Moreover, although the user information of the partner company CA can only be accessed from the partner company CA and the user information of the partner company CB can only be accessed from the partner company CB, the items of user information accessible from the respective partner companies C may be set individually. For example, the user information of the partner company CB may be set so as to be accessible from the partner company CA and the user information of the partner company CA may be set so as to be accessible from the partner company CB. The access to the user information from the respective partner companies C can be accepted or rejected based on the access right that the user information extracting unit 53 has set for the respective partner companies C in response to a request from the apparatuses of the partner companies C received by the user information extracting unit 53, for example.

Moreover, although the user information of the partner company C includes the visit history as described above; the visit history can be set based on the detection information obtained by the user terminal 5.

### 6. Hardware Configuration

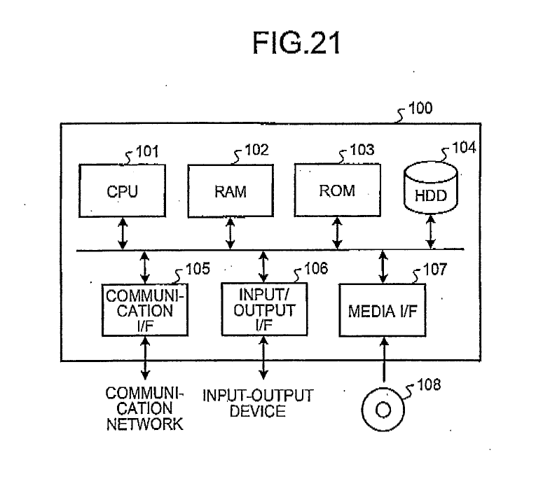

In the embodiment, the user information providing apparatus 2, 2A, or 2B and the advertisement distribution apparatus 3 are realized by a computer 100 having such a configuration as illustrated in FIG. 21, for example. FIG. 21 is a diagram illustrating a hardware configuration illustrating an example of a computer that realizes the functions of the user information providing apparatus 2, 2A, or 2B and the advertisement distribution apparatus 3.

The computer 100 includes a central processing unit (CPU) 101, random access memory (RAM) 102, read only memory (ROM) 103, a hard disk drive (HDD) 104, a communication interface (I/F) 105, an input/output interface (I/F) 106, and a media interface (I/F) 107.

The CPU 101 operates based on a program stored in the ROM 103 or the HDD 104 and controls respective units. The ROM 103 stores a booting program executed by the CPU 101 during startup of the computer 100, a program dependent on the hardware of the computer 100, and the like.

The HDD 104 Stores a program executed by the CPU 101 and data and the like used by the program. The communication interface 105 corresponds to the communication unit 30, receives data from other devices via the communication network 9, transmits the data to the CPU 101 and transmits the data generated by the CPU 101 to other devices via the communication network 9.

The CPU 101 controls an output device such as a display or a printer and an input device such as a keyboard or a mouse with the aid of the input/output interface 106. The CPU 101 acquires data from the input device via the input/output interface 106. Moreover, the CPU 101 outputs the generated data to the output device via the input/output interface 106.

The media interface 107 reads a program or data stored in a recording medium 108 and provides the same to the CPU 101 via the RAM 102. The CPU 101 loads the program from the recording medium 108 onto the RAM 102 via the media interface 107 and executes the loaded program. The recording medium 108 is an optical recording medium such as a digital versatile disc (DVD) or a phase change rewritable disk (PD), a magneto-optical recording medium such as a magneto-optical disk (MO), a tape medium, a magnetic recording medium, or semiconductor memory, for example.

When the computer 100 functions as the user information providing apparatus 2, 2A, or 2B, the CPU 101 of the computer 100 realizes the respective functions of the control unit 32, 32A, or 32B by executing the program loaded onto the RAM 102. Moreover, the HDD 104 realizes the functions of the storage units 31 and 31A. Moreover, when the computer 100 functions as the advertisement distribution apparatus 3, the CPU 101 of the computer 100 realizes the respective functions of the control unit 62 by executing the program loaded onto the RAM 102. Moreover, the HDD 104 realizes the functions of the storage unit 61.

Although the CPU 101 of the computer 100 reads these programs from the recording medium 108 and executes the same, as another example, the CPU 101 may acquire these programs from another device via the communication network 9.

### 7. Advantageous Effects

The user information providing apparatus 2, 2A, or 2B according to the embodiments includes the partnership information DB 41 (an example of a business operator information DB), the detection information acquiring unit 52, the user information extracting unit 53, 53A, or 53B, and the user information output unit 54. The partnership information DB stores the user information of the partner company C (an example of a business operator). The detection information acquiring unit 52 (an example of an information acquiring unit) acquires the identification target ID of the identification target 6 provided in a place corresponding to the partner company C from the user terminals 5, 5B, and 5C. The user information extracting unit 53, 53A, or 53B extracts the user information of the partner company C corresponding to the place where the identification target 6 is provided from the partnership information DB 41 based on the identification target ID acquired by the detection information acquiring unit 52. The user information output unit 54 outputs the extracted user information to the user information extracting unit 53, 53A, or 53B.

In this way, it is possible to distribute the advertisement information by narrowing down the user U of the partner company C and to promote purchase of items effectively and highly accurately.

Moreover, the user information extracting unit 53, 53A, or 53B extracts the user information corresponding to the user of the user terminal 5, 5B, or 5C among the items of user information of the partner company C corresponding to the place where the identification target 6 is acquired, acquired by the detection information acquiring unit 52 from the partnership information DB 41.

In this way, it is possible to distribute the advertisement information corresponding to the user information of the entering user U among the users U of the partner company C and to promote purchase of items effectively and highly accurately.

Moreover, the use information extracting unit 53, 53A, or 53B extracts the user information of the place where the identification target 6 is provided, acquired by the detection information acquiring unit 52 among the items of user information of the partner company C corresponding to the place where the identification target 6 is provided, acquired by the detection information acquiring unit 52 from the partnership information DB 41.

In this way, it is possible to distribute the advertisement information corresponding to the user information of the place that the user terminal 5, 5B, or 5C has entered and to promote purchase of items effectively and highly accurately.

Moreover, the user information extracting unit 53, 53A, or 53B extracts the user information of the place where the identification target 6 is provided, which corresponds to the user of the user terminal 5, 5B, or 5C and is acquired by the detection information acquiring unit 52 among the items of user information of the partner company C, which is acquired by the detection information acquiring unit 52 and which corresponds to the place where the identification target 6 is provided from the partnership information DB 41.

In this way, it is possible to distribute the advertisement information corresponding to the user information of the place that the user terminal 5, 5B, or 5C has entered to the user U of the partner company C and to promote purchase of items effectively and highly accurately.

Moreover, the user information providing apparatus 2 includes the behavior history DB 42 (an example of a behavior history storage unit) and the user information extracting unit 53 (an example of a determining unit). The behavior history DB 42 stores the behavior history of the user of the user terminal 5. When the information on the identification target 6 is acquired by the detection information acquiring unit 52, the user information extracting unit 53 determines whether or not to output the user information of the partner company C corresponding to the place where the identification target 6 is provided based on the behavior history of the user U of the user terminal 5. Based on the determination result, the user information extracting unit 53 extracts the user information of the partner company C corresponding to the place where the identification target 6 is provided from the partnership information DB 41.

In this way, it is possible to provide the advertisement information appropriate for the behavior of the user U to the user U. Moreover, the advertiser can post advertisement information under distribution conditions that the user U who frequently goes to a certain place is a distribution target and the advertiser can distribute advertisements efficiently and effectively. Moreover, since the user information providing apparatus 2 determines whether or not to output the user information whenever the information on the identification target 6 is acquired by the detection information acquiring unit 52, it is possible to distribute the advertisement information based on the latest behavior history.

Moreover, the user information providing apparatus 2A includes the list generating unit 55. The list generating unit 55 generates a list (identification target list) of items of information of the identification target 6 corresponding to the behavior history of the user U of the user terminal 5. The user information extracting unit 53A extracts the user information of the partner company C corresponding to the place where the identification target 6 is provided from the partnership information DB 41 when the information on the identification target 6 acquired by the detection information acquiring unit 52 is included in the identification target list.

In this way, it is possible to provide the advertisement information appropriate for the behavior of the user U to the user U. Moreover, the advertiser can post advertisement information under distribution conditions that the user U who frequently goes to a certain place is a distribution target and the advertiser can distribute advertisements efficiently and effectively. Moreover, since the user information providing apparatus 2A does not determine whether or not to output the user information whenever the information on the identification target 6 is acquired by the detection information acquiring unit 52, it is possible to mitigate the processing load of the user information providing apparatus 2A.

Moreover, the user information providing apparatus 2B includes the list generating unit 55B (an example of a list generating unit and a list transmitting unit). The list generating unit 55B generates a list (identification target list) of items of information on the identification target 6 corresponding to the behavior history of the user U of the user terminal 5B and transmits the generated list to the user terminal 5B. The detection information acquiring unit 52 acquires information on the identification target 6 included in the identification target list among the items of information on the identification target 6 provided in the place corresponding to the partner company C from the user terminal 5B.

In this way, it is possible to provide the advertisement information appropriate for the behavior of the user U to the user U. Moreover, the advertiser can post advertisement information under distribution conditions that the user U who frequently goes to a certain place is a distribution target and the advertiser can distribute advertisements efficiently and effectively. Further, since the user terminal 5B determines whether or not to output the user information, it is possible to mitigate the processing load of the user information providing apparatus 2B.

Moreover, the behavior history of the user U includes at least one of an entering state of the user U of the user terminal 5, 5B, or 5C into the place corresponding to the partner company C, a usage state of the coupon information of the place corresponding to the partner company C by the user U of the user terminal 5, 5B, or 5C, and an access state of the user U of the user terminal 5, 5B, or 5C to the advertisement information of the place corresponding to the partner company C.

in this way, it is possible to determine whether or not to output the user information based on an entering state of the user U into the place corresponding to the partner company C, the usage state of the coupon information by the user U, or the access state of the user U to the advertisement information.

Moreover, the advertisement distribution system according to the embodiment includes at least one of the user information providing apparatuses 2, 2A, and 2B and the advertisement distribution apparatus 3. The advertisement distribution apparatus 3 includes the advertisement DB 71, the advertisement information extracting unit 82, and the advertisement information output unit 83. The advertisement DB 71 stores a plurality of items of advertisement information. The advertisement information extracting unit 82 extracts the advertisement information corresponding to the user information output from the user information providing apparatus 2, 2A, or 2B from the advertisement DB 71. The advertisement information output unit 83 outputs the advertisement information extracted from the advertisement information extracting unit 82 to the user terminal 5, 5B, or 5C that has entered into the place corresponding to the partner company C.

In this way, an advertiser can distribute advertisement information to the user terminal 5 of the user U having designated user information among the users U using the partner company C by posting advertisement information of distribution conditions that designate the partner company C and the user attributes (for example, interests, concerns, and the like of the user U). Moreover, the advertiser can distribute advertisement information to the user terminal 5 of the user U having the user information corresponding to a designated store by further including designated stores in the distribution conditions. Thus, for example, when a manufacturer as an advertiser who provides items exhibited in the store of the partner company C posts advertisement information to the advertisement distribution apparatus 3, it is possible to distribute the advertisement information by narrowing down to the user U of the partner company C and to promote purchase of items effectively and highly accurately. Moreover, the user information of the partner company C includes a purchase history of items of a manufacturer and the like. Due to this, for example, it is possible to distribute the advertisement information by narrowing down to the user U who has a purchase history of the items advertised by the advertisement information. In this way, it is possible to promote purchase of items effectively and highly accurately.

### 8. Others

The user information providing apparatus 2, 2A, or 2B and the advertisement distribution apparatus 3 may be realized as one server computer. Moreover, the user information providing apparatus 2, 2A, or 2B and the advertisement distribution apparatus 3 may be realized as a plurality of server computers, and the configuration thereof may be changed flexibly in such a way that depending on their functions, an external platform and the like are invoked and realized by an application programming interface (API), a network computing, or the like.

According to an aspect of the embodiment, it is possible to provide a user information providing apparatus, a user information providing method, a user information providing program, and an advertisement distribution system capable of performing highly accurate targeting advertising.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A user information providing apparatus comprising:
a business operator information database configured to store user information of a business operator;
an information acquiring unit configured to acquire information on an identification target provided in a place corresponding to the business operator from a user terminal;
a user information extracting unit configured to extract user information of the business operator corresponding to the place where the identification target is provided from the business operator information database based on the information on the identification target acquired by the information acquiring unit; and
a user information output unit configured to output the user information extracted by the user information extracting unit.

2. The user information providing apparatus according to claim 1, wherein
the user information extracting unit extracts user information corresponding to a user of the user terminal among items of user information of the business operator, which are acquired by the information acquiring unit and correspond to the place where the identification target is provided, from the business operator information database.

3. The user information providing apparatus according to claim 1, wherein
the user information extracting unit extracts user information of the place where the identification target is provided, which is acquired by the information acquiring unit, among items of user information of the business operator, which are acquired by the information acquiring unit and correspond to the place where the identification target is provided, from the business operator information database.

4. The user information providing apparatus according to claim 1, wherein
the user information extracting unit extracts user information of the place where the identification target is provided, which corresponds to the user of the user terminal and is acquired by the information acquiring unit, among items of user information of the business operator, which are acquired by the information acquiring unit and correspond to the place where the identification target is provided, from the business operator information database.

5. The user information providing apparatus according to claim 1, further comprising:
a behavior history storage unit configured to store a behavior history of the user of the user terminal; and
a determining unit configured to determine whether or not to output the user information of the business operator corresponding to the place where the identification target is provided based on the behavior history of the user of the user terminal when the information on the identification target is acquired by the information acquiring unit, wherein
the user information extracting unit extracts the user information of the business operator corresponding to the place where the identification target is provided from the business operator information database based on a determination result of the determining unit.

6. The user information providing apparatus according to claim 1, further comprising:
a list generating unit configured to generate a list of items of information on the identification target corresponding to a behavior history of the user of the user terminal, wherein
the user information extracting unit extracts the user information of the business operator corresponding to the place where the identification target is provided from the business operator information database when the information on the identification target acquired by the information acquiring unit is included in the list.

7. The user information providing apparatus according to claim 1, further comprising:
a list generating unit configured to generate a list of items of information on the identification target corresponding to a behavior history of the user of the user terminal; and
a list transmitting unit configured to transmit the list generated by the list generating unit to the user terminal, wherein
the information acquiring unit acquires the information on the identification target included in the list among the items of information on the identification target provided in the place corresponding to the business operator from the user terminal.

8. The user information providing apparatus according to claim 5, wherein
the behavior history of the user includes at least one of an entering state of the user of the user terminal into the place corresponding to the business operator, a usage state of coupon information of the place corresponding to the business operator by the user of the user terminal, and an access state of the user of the user terminal to advertisement information of the place corresponding to the business operator.

9. An advertisement distribution system comprising:
a user information providing apparatus; and
an advertisement distribution apparatus, wherein
the user information providing apparatus includes
a business operator information database configured to store user information of a business operator,
an information acquiring unit configured to acquire information on an identification target provided in a place corresponding to the business operator from a user terminal,
a user information extracting unit configured to extract user information of the business operator corresponding to the place where the identification target is provided from the business operator information database based on the information on the identification target acquired by the information acquiring unit, and
a user information output unit configured to output the user information extracted by the user information extracting unit, and
the advertisement distribution apparatus includes
an advertisement database configured to store a plurality of items of advertisement information,
an advertisement information extracting unit configured to extract advertisement information corresponding to the user information output from the user information providing apparatus from the advertisement database, and
an advertisement information output unit configured to output the advertisement information extracted from the advertisement information extracting unit to a user terminal that has entered into the place corresponding to the business operator.

10. A user information providing method executed by a computer, comprising:
acquiring information on an identification target provided in a place corresponding to the business operator from a user terminal;
extracting user information of the business operator corresponding to the place where the identification target is provided from a business operator information database that stores the user information of the business operator based on the information on the identification target acquired in the acquiring and
outputting the user information extracted in the extracting.

11. A non-transitory computer readable storage medium containing program instructions for providing information, wherein execution of the program instructions by one or more processors of a computer system causes the one or more processors to perform:
acquiring information on an identification target provided in a place corresponding to the business operator from a user terminal;
extracting user information of the business operator corresponding to the place where the identification target is provided from the business operator information database which stores user information of a business operator, based on the information on the identification target acquired in the acquiring; and
outputting the user information extracted in the extracting.
